(19) United States
(12) Patent Application Publication
(10) Pub. No.: US 2026/0124890 A1
(43) Pub. Date: May 7, 2026

(54) ELECTRIC TRANSAXLE ASSEMBLY OF A WORK VEHICLE

(71) Applicant: Deere & Company, Moline, IL (US)

(72) Inventors: Randall L. Long, Coffeyville, KS (US); Saurabh Kulhare, Pune (IN); Anup N. Yadgire, Pune (IN)

(21) Appl. No.: 18/938,649

(22) Filed: Nov. 6, 2024

(51) Int. Cl. B60K 1/00; B60K 17/10; B60K 17/28

(52) U.S. Cl. CPC B60K 1/00; B60K 17/105; B60K 17/28; B60K 2001/001; B60K 2001/006; B60Y 2200/41

(57) ABSTRACT

Disclosed is an electric transaxle for a work vehicle. The electric transaxle includes a transaxle housing and an electric machine. The electric transaxle further includes a multiple-speed power shift transmission driven by the electric machine and including a first gear set with a first power shift clutch to provide a first speed ratio and a second gear set with a second power shift clutch to provide a second speed ratio different than the first speed ratio. The electric transaxle further includes a cooling system including a cooler cooling a cooling circuit configured to cool the electric machine. The electric transaxle further includes a hydraulic system including a hydraulic pump and a hydraulic circuit mounted to or contained at least in part within the transaxle housing to operate the first and second power shift clutches, the hydraulic circuit being cooled by the cooler of the cooling system.

### STATEMENT OF FEDERALLY SPONSORED RESEARCH OR DEVELOPMENT

Not applicable.

### FIELD OF THE DISCLOSURE

This disclosure generally relates to an electric transaxle of a work vehicle.

### BACKGROUND OF THE DISCLOSURE

Heavy-duty work vehicles, such as those used in the agricultural, construction, forestry, and mining industries, can have a transmission system with a high-speed gearing and low-speed gearing that are selected based on the operations being performed by the work vehicle. The gearing systems can be driven by an electric machine that is powered by batteries. The shifting between the high-speed gearing and low-speed gearing can be performed with a clutch. The electric machine and transmission can be lubricated with hydraulic fluid.

### SUMMARY OF THE DISCLOSURE

An electric transaxle includes a transaxle housing and an electric machine mounted to or contained at least in part within the transaxle housing. The electric transaxle further includes a multiple-speed power shift transmission driven by the electric machine and including a first gear set with a first power shift clutch to provide a first speed ratio and a second gear set with a second power shift clutch to provide a second speed ratio different than the first speed ratio. The electric transaxle further includes a cooling system including a cooler cooling a cooling circuit mounted to or contained at least in part within the transaxle housing and configured to cool the electric machine. The electric transaxle further includes a hydraulic system including a hydraulic pump and a hydraulic circuit mounted to or contained at least in part within the transaxle housing to operate the first and second power shift clutches of the first and second gear sets, the hydraulic circuit being cooled by the cooler of the cooling system.

In an example of the electric transaxle, the first gear set is identical to the second gear set and the first and second gear sets are arranged in opposite axial orientations. In a further example of the electric transaxle, the first gear set is identical to the second gear set and the first and second gear sets are arranged in opposite axial orientations. In a further example of the electric transaxle, the first gear set includes a first shaft extending along a first rotation axis and carrying a first large gear spaced along the first rotation axis from a first small gear, and the second gear set includes a second shaft extending along a second rotation axis, parallel to the first rotation axis, and carrying a second large gear, identical to the first large gear, spaced along the second rotation axis from a second small gear, identical to the first small gear. The first small gear meshes with the second large gear to provide the first speed ratio and the first large gear meshes with the second small gear to provide the second speed ratio. In a further example of the electric transaxle, the multiple-speed power shift transmission provides power at the first speed ratio when the first power shift clutch is engaged and the second power shift clutch is disengaged and the multiple-speed power shift transmission provides power at the second speed ratio when the second power shift clutch is engaged and the first power shift clutch is engaged.

In a further example of the electric transaxle, the electric transaxle further includes an output gear coupled to or part of the second shaft of the second gear set. The output gear outputting power at the first speed ratio when the first power shift clutch is engaged and the second power shift clutch is disengaged and at the second speed ratio when the second power shift clutch is engaged and the first power shift clutch is disengaged. In a further example of the electric transaxle, the output gear is a spiral bevel gear meshing with a face of drive ring gear of the transaxle.

In a further example of the electric transaxle, the electric transaxle further includes a differential mounted to or contained at least in part within the transaxle housing and receiving power from the drive ring gear. In a further example of the electric transaxle, the electric transaxle further includes a first final drive mounted to or contained at least in part within the transaxle housing at a first side of the differential and providing a final gear ratio to a first hub configured to mount a first ground-engaging wheel or track; and a second final drive mounted to or contained at least in part within the transaxle housing at a second side of the differential and providing the final gear ratio to a second hub configured to mount a second ground-engaging wheel or track.

In a further example of the electric transaxle, the electric transaxle further includes one or more of: a first power take off assembly or a second power take off assembly. The first power take off assembly mounted to or contained at least in part within the transaxle housing and configured to receive power from or transmit power to the multiple-speed power shift transmission at the first speed ratio or the second speed ratio. The second power take off assembly mounted to or contained at least in part within the transaxle housing and configured to receive power from or transmit power to the multiple-speed power shift transmission at the first speed ratio or the second speed ratio. In a further example of the electric transaxle, the first power take off assembly is a part of a continuous four wheel drive assembly and wherein the second power take off assembly is a part of a mechanical momentary four wheel drive assembly.

A work vehicle includes a chassis supported off the ground by ground-engaging wheels or tracks and an electric transaxle carried by the chassis and driving the ground-engaging wheels or tracks. The electric transaxle includes a transaxle housing and an electric machine mounted to or contained at least in part within the transaxle housing. The electric transaxle further includes a multiple-speed power shift transmission driven by the electric machine and including a first gear set with a first power shift clutch and providing a first speed ratio and a second gear set with a second power shift clutch and providing a second speed ratio different than the first speed ratio. The electric transaxle further includes a cooling system including a cooler cooling a cooling circuit mounted to or contained at least in part within the transaxle housing and configured to cool the electric machine. The electric transaxle further includes a hydraulic system including a hydraulic pump and a hydraulic circuit mounted to or contained at least in part within the transaxle housing to operate the first and second power shift clutches of the first and second gear sets, the hydraulic circuit being cooled by the cooler of the cooling system.

In an example of the work vehicle, the first gear set is identical to the second gear set and the first and second gear sets are arranged in opposite axial orientations. In a further example of the work vehicle, the first gear set includes a first shaft extending along a first rotation axis and carrying a first large gear spaced along the first rotation axis from a first small gear; and the second gear set includes a second shaft extending along a second rotation axis, parallel to the first rotation axis, and carrying a second large gear, identical to the first large gear, spaced along the second rotation axis from a second small gear, identical to the first small gear. The first small gear meshes with the second large gear to provide the first speed ratio and wherein the first large gear meshes with the second small gear to provide the second speed ratio. In a further example of the work vehicle, the multiple-speed power shift transmission provides power at the first speed ratio when the first power shift clutch is engaged and the second power shift clutch is disengaged; and the multiple-speed power shift transmission provides power at the second speed ratio when the second power shift clutch is engaged and the first power shift clutch is engaged.

In a further example of the work vehicle, the electric transaxle further includes an output gear coupled to or part of the second shaft of the second gear set and outputting power at the first speed ratio when the first power shift clutch is engaged and the second power shift clutch is disengaged and at the second speed ratio when the second power shift clutch is engaged and the first power shift clutch is engaged. In a further example of the work vehicle, the output gear is a spiral bevel gear meshing with a face of drive ring gear of the transaxle.

In a further example of the work vehicle, the work vehicle includes a differential mounted to or contained at least in part within the transaxle housing and receiving power from the drive ring gear. In a further example of the work vehicle, the work vehicle further includes a first final drive mounted to or contained at least in part within the transaxle housing at a first side of the differential and providing a final gear ratio to a first hub configured to mount a first of the ground-engaging wheels or tracks; and a second final drive mounted to or contained at least in part within the transaxle housing at a second side of the differential and providing the final gear ratio to a second hub configured to mount a second of the ground-engaging wheels or tracks.

In a further example of the work vehicle, the work vehicle further includes one or more of a first power take off assembly or a second power take off assembly. The first power take off assembly mounted to or contained at least in part within the transaxle housing and configured to receive power from or transmit power to the multiple-speed power shift transmission at the first speed ratio or the second speed ratio. The second power take off assembly mounted to or contained at least in part within the transaxle housing and configured to receive power from or transmit power to the multiple-speed power shift transmission at the first speed ratio or the second speed ratio. In a further example of the work vehicle, the first power take off assembly is a part of a continuous four wheel drive assembly and wherein the second power take off assembly is a part of a mechanical momentary four wheel drive assembly.

Other features and aspects will become apparent by consideration of the detailed description, claims, and accompanying drawings.

### BRIEF DESCRIPTION OF THE DRAWINGS

FIG. 1 is an example work vehicle in the form of a wheel loader, having an electric transaxle according to the present disclosure;

FIG. 2 is a schematic diagram of an example control system of the work vehicle of FIG. 1;

FIG. 3 is a perspective view of an example electric transaxle of the work vehicle of FIG. 1;

FIG. 4 is a front elevated view of the electric transaxle of FIG. 3;

FIG. 5 is a side elevated view of the electric transaxle of FIG. 3;

FIG. 6 is a perspective view of the electric transaxle of FIG. 3 with the electric transaxle housing removed;

FIG. 7 is a perspective view of multiple-speed power shift transmission and power take off assemblies of the electric transaxle of FIG. 3;

FIG. 8 is an exploded view thereof on a first rotation axis of the multiple-speed power shift transmission and power take off assemblies;

FIG. 9 is an exploded view thereof on a second rotation axis of the multiple-speed power shift transmission and power take off assemblies;

FIG. 10 is an exploded view of another power take off assembly of the electric transaxle of FIG. 7;

FIG. 11 is a sectional view taken along line 11-11 of FIG. 3;

FIG. 12A is an enlarged detail view showing area 12A-12A of FIG. 11;

FIG. 12B is an enlarged detail view showing area 12B-12B of FIG. 11; and

FIG. 13 is a sectional view taken along line 13-13 of FIG. 3.

Throughout the drawings, identical reference numbers designate the same element. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

The following disclosure describes one or more example embodiments of the disclosed electric transaxle for a work vehicle as shown in the accompanying figures of the drawings described briefly above. Various modifications to the example embodiments may be contemplated by one of skill in the art. Discussion herein focuses on an electric transaxle for a gearing system of a work vehicle, such as a wheeled loader, but the electric transaxle disclosed herein may be utilized in other contexts, including other work vehicle platforms in the agriculture, construction, forestry, mining, and other industries.

### Overview

The work vehicle can be driven by an electric transaxle, where an electric machine drives a multiple-speed power shift transmission that can switch between a high-speed gearing and a low-speed gearing based on the operation of the work vehicle. Batteries are used to power the electric machine. These batteries can require space and weight that is generally reserved for the transmission system. As such, there is a need to move the transmission system to the axles to make space to allow for optimal positioning of the batteries.

The present disclosure provides an electric transaxle for a work vehicle that moves the transmission system to two parallel axles of the work vehicle. The electric transaxle includes an electric machine driving a multiple-speed power shift transmission. The multiple-speed power shift transmission includes a first gear set with a first power shift clutch to provide a first speed ratio and a second gear set with a second power shift clutch to provide a second speed ratio different than the first speed ratio. The first gear set includes a first shaft extending along a first rotation axis and carrying a first large gear spaced along the first rotation axis from a first small gear. The second gear set includes a second shaft extending along a second rotation axis, parallel to the first rotation axis. The second shaft carries a second large gear, identical to the first large gear, spaced along the second rotation axis from a second small gear, identical to the first small gear. The first small gear meshes with the second large gear to provide the first speed ratio to the second shaft and the first large gear meshes with the second small gear to provide the second speed ratio to the second shaft.

The gear sets are mirror images of each other. The electric machine drives the first shaft. In some aspects, the electric machine drives a planetary gear set and the output of the planetary gear set drives the first shaft. When the first power shift clutch is engaged and the second power shift clutch is disengaged, the first and second gear sets cause the second shaft to output power at a first speed ratio. When the first power shift clutch is disengaged and the second power shift clutch is engaged, the first and second gear sets cause the second shaft to output power at a second speed ratio. The first shaft can rotate at a first speed and the speed of the second shaft can rotate at a second speed when the first power shift clutch is engaged and a third speed when the second power shift clutch is engaged. Since the gear sets are mirror images of each other, the first speed is between the second speed and the third speed. In some aspects, the first speed is exactly in the middle between the second speed and the third speed.

The hydraulic fluid lubricating the electric transaxle can also be used to cool the components of the electric transaxle. The work vehicle includes a first cooling system. The electric transaxle can include a second cooling system including a cooling circuit and a cooler for cooling the hydraulic fluid. The cooling circuit can connect to a cooling circuit of the first cooling system of the work vehicle. For example, the second cooling system of the electric transaxle can receive cooling fluid (e.g. glycol) from the first cooling system, run that fluid through the second cooling system to cool components of the electric transaxle and then return the cooling fluid to the first cooling system to be cooled. The second cooling system can be used to cool an inverter, a liquid cooler for cooling the hydraulic fluid inside the electric transaxle, and an electric machine to drive a hydraulic pump. Using the cooling fluid to cool multiple things of the electric transaxle helps to reduce the overall size of the vehicle cooling package.

An electric machine can drive a hydraulic pump to pump the hydraulic fluid from an oil sump through a hydraulic circuit. The hydraulic circuit includes a manifold block. The manifold block disburses the hydraulic fluid through the hydraulic circuit to engaged/disengaged the first and second power clutches through an electric transaxle housing. For example, some of the hydraulic circuit can be positioned within the electric transaxle housing. The excess flow of hydraulic fluid can travel out of the manifold block and to the liquid cooler to allow the cooling fluid to cool the hydraulic fluid. The hydraulic fluid can then exit the liquid cooler and enter the electric transaxle housing at the electric machine. The hydraulic fluid can cool the electric machine and travel through the electric transaxle to the oil sump at the bottom of the housing. For example, the hydraulic fluid can travel through to cool and lubricate the electric machine, the multiple-speed power shift transmission, a planetary gear set, the power take off assemblies, etc.

The electric transaxle is designed to have few connections to the work vehicle, which allows the electric machine to be easily positioned into a work vehicle and connected. The connections of the electric transaxle include a DC bus connection for power, a communication connection to connect to a controller of the work vehicle, and an input and an output for cooling fluid from the work vehicle to couple to the cooling system of the electric transaxle. These few connections make it easier to position and connect the electric transaxle in a variety of different types of work vehicles. For example, the hydraulic fluid used in the electric transaxle is fully contained within the electric transaxle and as such does not need a connection to the work vehicle. This helps making it easier to place the electric transaxle in a variety of different work vehicles.

In some aspects, the electric transaxle may include a parking brake. This can allow any separate park brakes to be removed from the work vehicle saving space there as well. The park brake can be positioned on the second shaft and be couple to the electric transaxle housing. When the park brake is engaged, the parking brake provides a frictional force between the electric transaxle housing and the second shaft to prevent the second shaft from rotating. For example, a brake pad can be fixed to the electric transaxle housing and a braking member can be mechanically coupled to the second shaft. When engaged, an actuator can press the braking member toward the brake pad to provide a frictional force between the brake pad and the second shaft to prevent the second shaft from rotating.

The electric transaxle can include one or more power take off assemblies that are driven by a drive shaft in the electric transaxle. The power take off assemblies are each configured to receive power from the multiple-speed power shift transmission at the first speed ratio or the second speed ratio. The power take off assemblies can be mechanically coupled to drive the front ground engaging members. For example, one of the power take off assemblies can be used to drive the front ground engaging members through a front differential assembly. The electric transaxle can have one power take off assembly that is for continuous four wheel drive and another power take off assembly for mechanical momentary four wheel drive. Either or none of the power take off assemblies can be used to drive the front ground engaging members. For example, none of the assemblies being used would result in an always rear wheel driven work vehicle, continuous four wheel drive would result in a constant four wheel driven work vehicle, and the mechanical momentary four wheel drive would result in a work vehicle where the operator can decide when the work vehicle is four wheel driven. Any power take off assembly not being used could be not installed in the work vehicle. Alternatively, all the power take off assemblies could be installed with only the desired one or none being used. As such, the type of four wheel drive mode for the work vehicle can be selected based on the type of work vehicle or can be chosen upon manufacturing.

One or more example embodiments of an electric transaxle for a work vehicle are provided in the figures of the present disclosure. The following description should be understood as merely providing a non-limiting example context in which embodiments of the present disclosure may be better understood.

### Example Electric Transaxle for a Work Vehicle

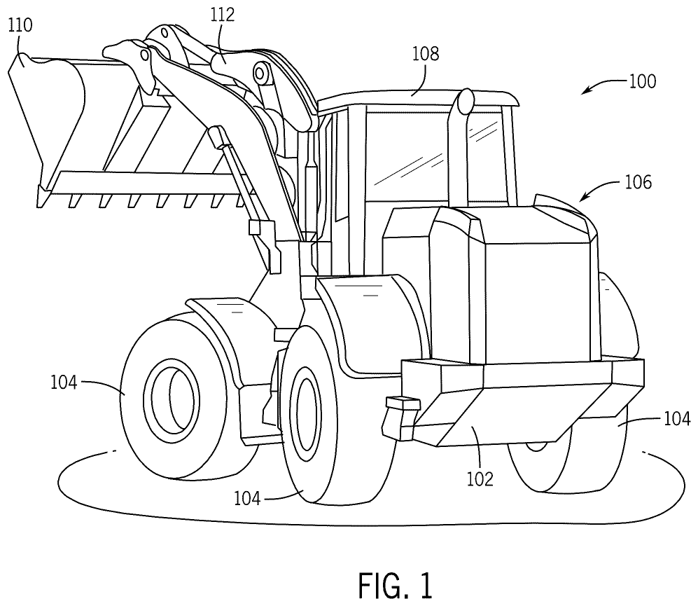

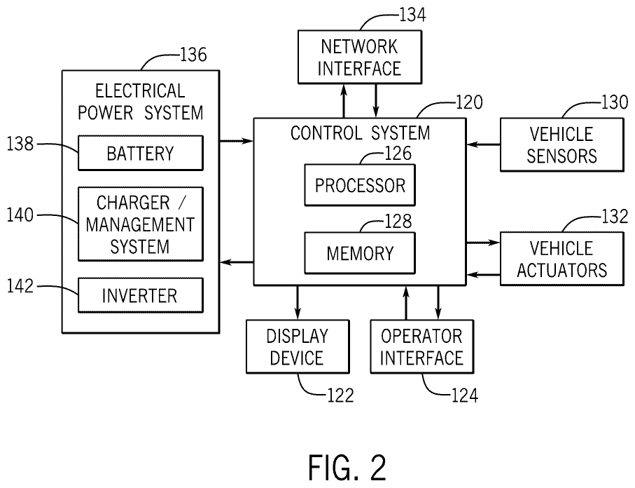

Referring to FIGS. 1 and 2, a work vehicle 100 is implemented as a wheel loader or any other heavy-duty work vehicle such as those used in the agricultural, construction, forestry and mining industries. The work vehicle 100 includes a chassis 102 mounting a plurality of ground-engaging members 104, such as wheels or tracks, supporting the chassis 102 off the ground. Supported on the chassis 22 is an engine bay housing 106 and an operator cabin 108 to be occupied by an operator of the work vehicle 100. It should be understood that the present disclosure may also pertain to autonomous work vehicles, in which case the operator cabin may be omitted. The work vehicle further includes a front bucket 110 mechanically linked to a forward portion of the chassis 102 by a boom assembly 112.

The operator cabin 108 may include one or more display devices 122 and any of various operator interfaces 124 coupled to a control system 120. Apart from the display devices 122, the operator interface devices 124 may include various video and audio devices for providing video and audio information, haptic devices that provide haptic feedback, levers, joysticks, steering wheels, pedals, buttons, and so on. Operator interface devices 124 can also be a set of inputs displayed on the display devices 122, for example, links, icons, or other user actuatable mechanisms. Additionally, or alternatively, some portion of the operator interfaces 124 may be integrated into the display devices 122, such that the operator interfaces 124 may include physical inputs (e.g. buttons, switches, dials, etc.) on or near the display devices 122, a touchscreen module integrated into the display devices 122, or a cursor input device (e.g., a joystick, trackball, or mouse) for positioning a cursor utilized to interface with GUI elements generated on the display devices 122. The display devices 122 can be any image-generating device configured for operation within the operator cabin 108, including one or more dedicated display consoles and various heads-up display projectors.

The display devices 122 and operator interfaces 124 are operatively coupled to the control system 120 with various data connections between these components represented by a number of signal lines generally representative of wired and/or wireless data connections. The control system 120 has one or more controllers or other control architecture that can assume any form suitable for performing the functions described herein, and is used in a non-limiting sense to generally refer to the processing architecture or system of the work vehicle 100 or other computing device or group of devices. For example, the control system 120 can encompass or may be corresponding to any practical number of processors, control computers, computer-readable memories, power supplies, storage devices, interface cards, and other standardized components, and may also include or cooperate with any number of firmware and software programs or computer-readable instructions designed to carry-out the various process tasks, calculations, and control/display functions described herein, all represented by a processor 126. Such computer-readable instructions may be stored within a non-volatile sector of a local onboard memory 128, which is accessible to the control system 120. While generically illustrated as a single block, the memory 128 can encompass any number and type of storage media suitable for storing computer-readable code or instructions, as well as other data utilized to support the operation of the work vehicle 100. The memory 128 may be integrated into the controller architecture in various embodiments such as, for example, a system-in-package, a system-on-a-chip, or another type of microelectronic package or module.

The work vehicle 100 may include various onboard sensors and actuators referred to herein collectively by reference numbers 130 and 132, respectively, and a network interface 134. For example, the work vehicle 100 can include a ground speed sensor that senses the travel speed of work vehicle 100 over a field, for example, by sensing the speed of rotation of the ground-engaging members 104, a drive shaft, the axle, or other components. The travel speed can also be sensed by a positioning system, such as a global positioning system (GPS), a dead reckoning system, a LORAN system, or a wide variety of other systems or sensors that provide an indication of travel speed and heading. The onboard sensors 130 can include various different types of sensor architectures for providing the control system 120 with input pertaining to the operational parameters of the work vehicle 100, data pertaining to the surrounding environment of the work vehicle 100, and other such information useful to operation of the work vehicle 100. The onboard sensors 130 may include some form of receiver, chip set, or the like for determining position utilizing a satellite navigation system including, but not limited to, GPS, Galileo, Global Navigation Satellite System (GNSS or GLONASS), Compass-IGS01, and combinations of the satellites included therein. The onboard sensors 130 can also include various linear and angular position sensors, inertial sensors (e.g., micro-electro-mechanical system inertial measurement units “MEMS IMU” devices), strain sensors, pressure sensors, motor speed sensors, temperature sensors, moisture sensors, wear sensors, vibration sensors, image sensors or cameras, and/or sensors for measuring radio frequency (RF) signals.

Various ones or combinations or the foregoing (or other) sensors will be capable of sensing the travel speed, heading, and spatial orientation (e.g., pitch, roll, and yaw) of the work vehicle 100. Moreover, various ones or combinations or the foregoing (or other) sensors will be capable of sensing the load characteristics (e.g., mass, center of mass, height, etc.) of the work vehicle 100, including loading at work implements attached to or carried onboard the work vehicle 100 (e.g., loader, backhoe, etc.) and work implements towed behind or driven at the front of the work vehicle 100 (e.g., tillage equipment, baler, plow, etc.)

Similarly, the actuators 132 onboard the work vehicle 100 may assume different forms for performing functions supporting its operation. For example, the actuators 132 may serve to provide tractive force to the ground-engaging members 104, operate pneumatic and hydraulic systems if being used, and impart linear or angular motion to work implements attached to the work vehicle 100. The actuators 132 may take any of various forms, including various motors, pumps, linear actuators (e.g., cylinders), solenoids and other valves, clutches, brakes, and any other mechanism that may transmit power from one component to another. The actuators 132 may include mechanical, electrical, and/or hydraulic aspects and thus may be coupled to and receive power from the electrical power system 136.

It should be understood that that the aforementioned onboard sensors 130 and actuators 132 may include any number of sensors and actuators located to sense parameters of various attachments that are propelled by the work vehicle 100. Such attachments may include towed implements attached to the rear of the work vehicle 100 (e.g., various tillage equipment, balers, sprayers, windrowers, backhoes, etc.) as well as implements that attached to the front end of the work vehicle 100 (e.g., various loaders, plows, brushes, etc.). These attachments may receive various forms of power (e.g., electric and hydraulic) so as to be a part of the electrical power system 136, or they may have separate self-contained power systems or be otherwise unpowered.

The network interface 134 can be any device or module providing access to a network, such as a wireless (e.g., WiFi or cellular) transceiver or datalink, including an antenna. The network interface 48 can also include a satellite receiver and may receive data via a satellite link and may allow communication with nearby cellular towers or terrestrial nodes, such as wireless RF nodes included in a controller area network (“CAN”) established over an agricultural area (e.g., a field or group of fields) within which the work vehicle 100 operates. Suitable equipment for usage as the network interface 134 includes the line of telematics receivers and transmitters commercially offered by Deere & Company, currently headquartered in Moline, Ill., and marketed under the brand name “JDLink™”. Such examples notwithstanding, the particular form assumed by the network interface 48 may vary, providing that network interface 134 provides persistent or intermittent wireless conductivity to the network.

The electrical power system 136 may include one or more battery packs 138 that may include battery cells as well as associated circuitry for delivering power to and from the battery cells of various technologies (e.g., lead acid, lithium, lithium ion, lithium sulfur, lithium iron phosphate, lithium cobalt, nickel metal hydride, nickel cadmium, ultracapacitors, etc.). The battery packs 138 may include temperature sensors and conduits for conducting coolant through the battery packs 138. The electrical power system 136 may include a battery management system (“BMS”) 140, which may, for example, manage its charging, detect low-charge conditions, and predict remaining run-time. The BMS 140 may also provide information about the current, voltage, and temperature of the battery packs 138. The BMS 140 may also employ chargers, added to or embedded in the battery packs 138, to charge the battery packs 138 to optimal levels and temperatures. The BMS 140 may include or utilize a general-purpose input/output (“GPIO”) interface to communicate with battery pack 138. The electrical power system 28 may include one or more inverters 142 to convert direct current (“DC”) into alternating current (“AC”). The inverters 142 may take any suitable form, such as an insulated-gate bipolar transistor (“IGBT”) inverter and a silicon carbide (“SiC”) inverter. The inverters 142 may receive DC current from the battery packs 138 through the GPIO interface and DC bus for receiving DC current from the battery packs 138. The inverters 142 may also receive power from other sources (e.g., an onboard generator or regenerative braking) which may be converted to DC current by the inverter 142 and supplied to the battery packs 138 via the GPIO interface and DC bus.

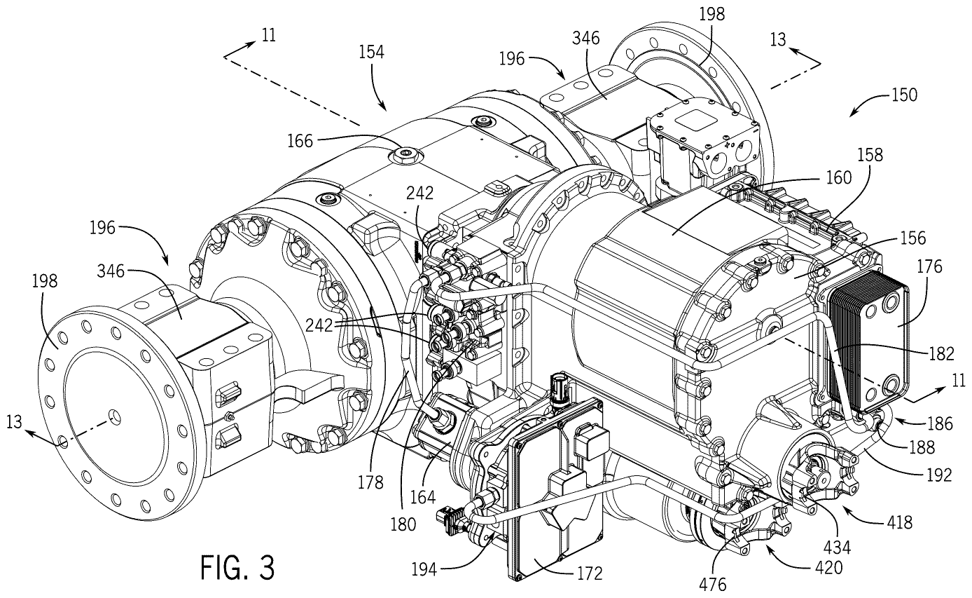

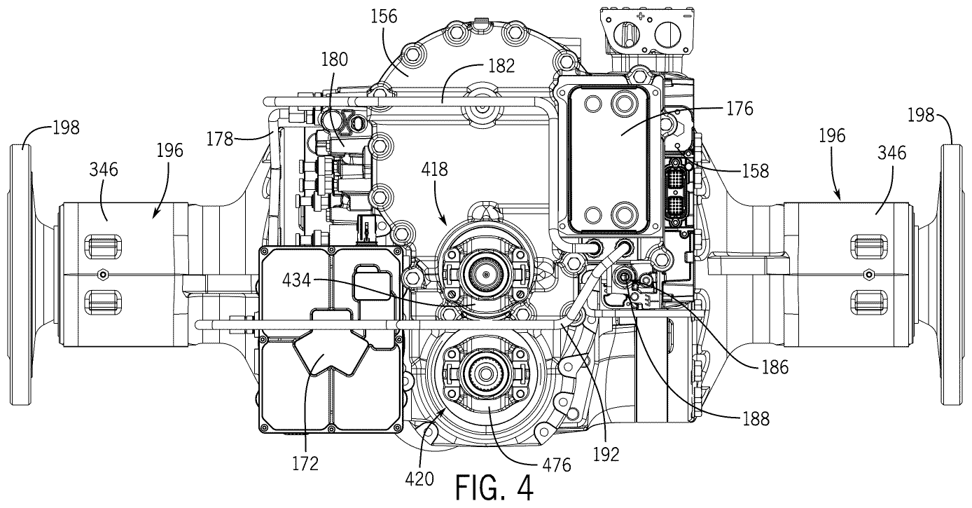

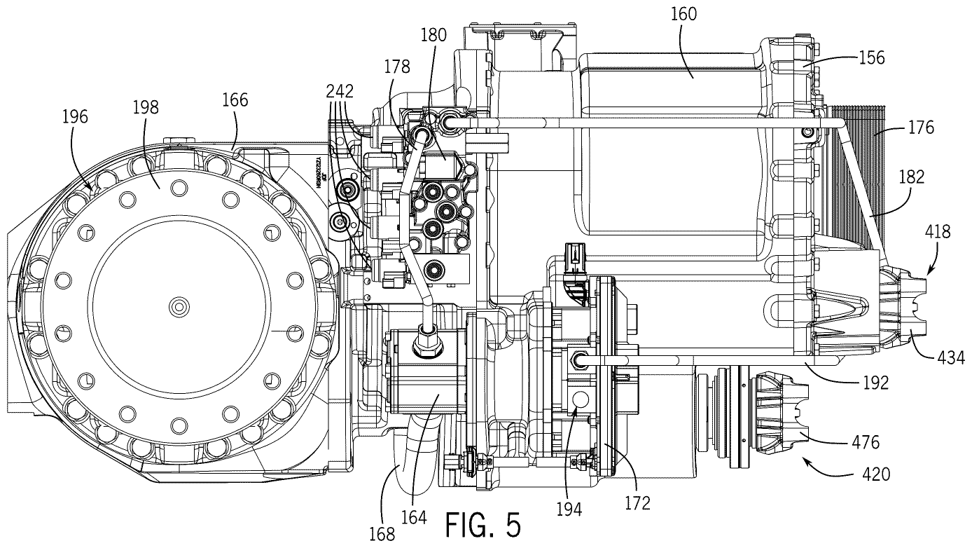

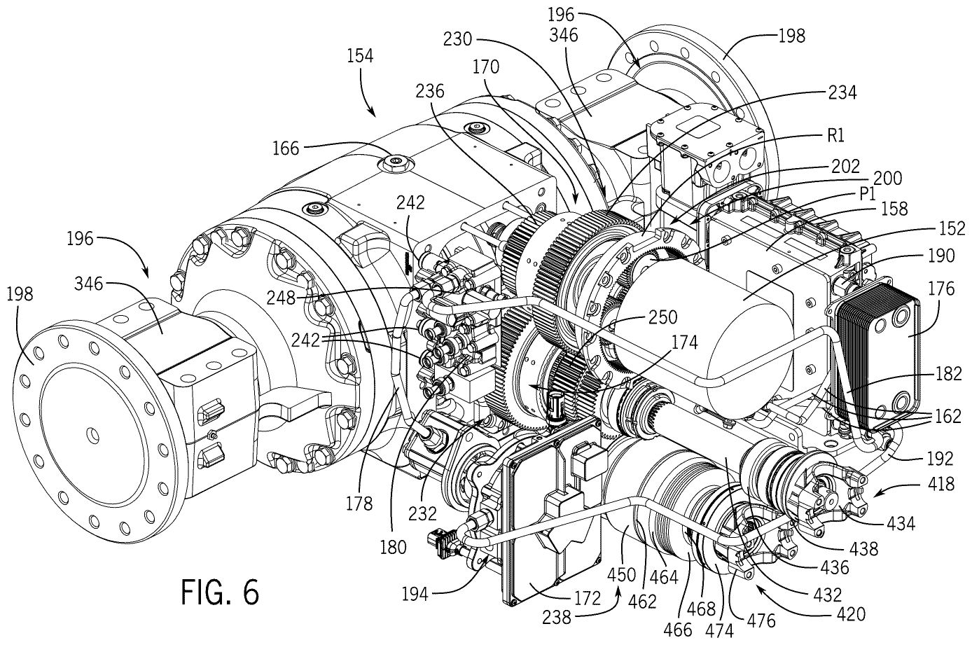

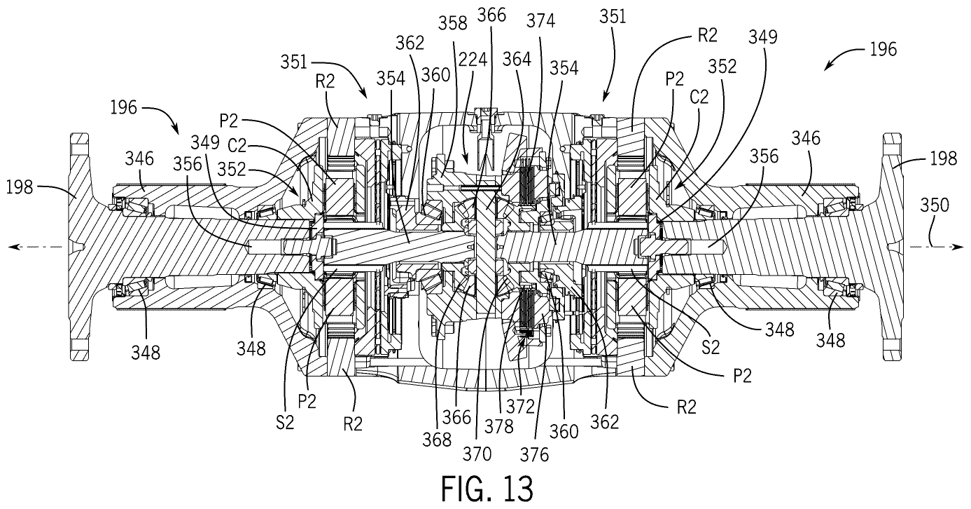

FIGS. 3-13 illustrate an example electric transaxle 150 including an electric machine 152 (i.e., actuator 132) that can be positioned within the engine bay housing 106 and a multiple-speed power shift transmission 154 to couple the electric machine 152 to the ground engaging members 104. Referring also to FIG. 3, the electric transaxle 150 includes an electric transaxle housing 160 housing the components of the electric transaxle 150, an end plate 156 attached to the electric transaxle housing 160, and a differential housing 166. The electric transaxle housing 160 is attached to the differential housing 166. The electric transaxle housing 160 encloses the electric machine 152 and the multiple-speed power shift transmission 154. The electric transaxle 150 includes an inverter 158 (e.g., inverter 142) attached to the housing 160. The inverter 158 is coupled to the electric machine 152 through wires 162 (FIG. 6).

Referring also to FIGS. 3-6, the electric machine 152 and multiple-speed power shift transmission 154 are lubricated and cooled by hydraulic fluid. An electric machine 172 drives a hydraulic pump 164 that pumps hydraulic fluid from an oil sump and through a hydraulic circuit. The electric machine 172 is coupled to the hydraulic pump 164 by a coupler that connects an output shaft of the electric machine 172 and an input shaft of the pump. The coupler can extend through two bearings, where the bearings are held in position relative to the electric transaxle housing 160. The bearings allow the coupler to rotate relative to the electric transaxle housing 160.

The hydraulic pump 164 pulls hydraulic fluid from an oil sump and through passageway 168 to the hydraulic pump 164 and then pumps the hydraulic fluid through the hydraulic circuit to reach a first power shift clutch 170, a second power shift clutch 174, a third power shift clutch 238, a parking brake assembly 388, and a cooler 176. The hydraulic fluid travels through a passageway 178 to a manifold 180. The manifold 180 distributes hydraulic fluid through passageways in the electric transaxle housing 160 to operate the first power shift clutch 170, the second power shift clutch 174, the third power shift clutch 238, and parking brake assembly 388 as desired by an operator. The manifold 180 includes valves 242 that can be operated by the control system 120 to direct the hydraulic fluid out of the manifold as desired to engaged one or more of the first power shift clutch 170, the second power shift clutch 174, the third power shift clutch 238, and parking brake assembly 388. For example, the operator can use the operator interface 124 and cause the manifold 180 to distribute the hydraulic fluid to engage the power shift clutches 170, 174, 238 and/or parking brake 388 to operate the work vehicle as desired.

Excess hydraulic fluid is pumped out of the manifold 180 and through passageway 182 to reach the cooler 176. The hydraulic fluid is cooled in the cooler 176 and exits the cooler 176 through and into the electric transaxle housing 160. The hydraulic fluid cools and lubricates the electric machine 152 and travels through the multiple-speed power shift transmission 154 lubricating and cooling components of the multiple-speed power shift transmission 154. The hydraulic fluid travels through the multiple-speed power shift transmission 154 to reach the oil sump. The hydraulic fluid cycles through the hydraulic circuit described above being pumped by the hydraulic pump 164.

The cooler 176 performs liquid to liquid cooling using a cooling liquid to cool the hydraulic fluid. The cooler 176 is part of a cooling system of the electric transaxle 150. The cooling system includes a cooling circuit and the cooler 176. The cooling system passes a cooling liquid through the cooling circuit to cool the inverter 158, hydraulic fluid in the cooler 176, and electric machine 172. The cooling liquid comes from a cooling circuit of the work vehicle 100. In at least one aspect, the cooling liquid is glycol. The cooling liquid enters the cooling system of the electric transaxle at an input 186 and through a coupler 188 into the inverter 142. The cooling liquid cools the inverter 142.

The cooling liquid exits the inverter 142 through a coupler 190 and into the cooler 176. The coupler 190 is positioned within the electric transaxle housing 160. The cooling fluid is used to perform liquid to liquid cooling of the hydraulic fluid within the cooler 176. The cooling fluid exits the cooler 176 and travels through passageway 192 to reach electric machine 172. The cooling fluid cools the electric machine 172 and exits the electric machine 172 at the output 194. A coupler can be attached to the output 194 to couple the output 194 to the cooling circuit of the work vehicle 100. The cooling system of the work vehicle 100 cools the cooling fluid and pumps it through the cooling system of the work vehicle 100 and back through the cooling circuit of the electric transaxle 150.

The electric machine 152 drives the multiple-speed power shift transmission 154 to drive the ground engaging members 104 of the work vehicle 100. The rear ground engaging members 104 can be attached to wheel end units 196, such as by securing bolts through matching bolt hole patterns on rotatable hubs 198 of the wheel end units 196 and the mating hubs of the ground-engaging member 104. The wheel end units 196, in the depicted example, are essentially identical (i.e., symmetric left and right versions of the same) and configured to attach a rear left and rear right ground engaging member 104. In an alternative aspect, the wheel end units 196 could be used to attach a front left and front right ground engaging member 104. The wheel end units 196 are attached to the differential housing 166.

Referring also to FIGS. 6-12A, the multiple-speed power shift transmission 154 includes a planetary gear set 200. The electric machine 152 drives the planetary gear set 200 that drives a drive shaft 210. The planetary gear set 200 includes a sun gear S1, planet gears P1, a ring gear R1, and a carrier C1. The ring gear R1 is stationary and is attached to the electric transaxle housing 160. For example, the ring gear R1 can include a peripheral edge 202 that include teeth or protrusions that mesh with the electric transaxle housing 160 to maintain the ring gear R1 is a stationary position. The electric machine 152 includes an output shaft 204 extending from the electric machine 152. The output shaft 204 is coupled to drive the sun gear S1 such that the rotation of the output shaft 204 drives the sun gear S1 about rotation axis 206. For example, the output shaft 204 can include teeth that are meshed with teeth of the sun gear S1. The sun gear S1 is coupled to the planet gears P1, where teeth of the sun gear S1 are meshed with teeth of the planet gears P1. As such, rotation of the sun gear S1 causes the planet gears P1 to rotate around the sun gear S1 and the rotation axis 206. The teeth of the planet gears P1 are meshed with teeth of the ring gear R1 such that the planet gears P1 react against the stationary ring gear R1 to rotate around the sun gear S1. The planet gears P1 are attached to a carrier C1 by pins 208 or bolts, where the planet gears P1 can rotate relative to the carrier C1. For example, the carrier C1 includes shaft 216 and the planet gears P1 are placed and attached to the shafts 216 such that the planet gears P1 can rotate relative to the shafts 216. The movement of the planet gears P1 around the rotation axis 206 causes the carrier C1 to rotate about the rotation axis 206. The carrier C1 is meshed with drive shaft 210 such that rotation of the carrier C1 rotates the drive shaft 210. For example, splines 212 on the drive shaft 210 can mesh with splines 214 on the carrier C1. As such, the planetary gear set 200 is sun in and carrier out. In at least one aspect, the planetary gear set 200 is used to reduce the rotation per minute (RPM) and increase the torque from the electric machine 152. As such, the RPM is lower, and torque is higher at the drive shaft 210 than at the output shaft 204.

The drive shaft 210 extends away from the carrier C1 and passes through two bearings 218 toward opposite ends of the drive shaft 210. The bearings 218 allow the drive shaft 210 to freely rotate while supporting and holding the drive shaft 210 in position. The bearings 218 can be held in position by the electric transaxle housing 160. For example, a protrusion 220 of the electric transaxle housing 160 can be positioned to hold one bearing 218 and allow the drive shaft 210 to extend through and the other bearing 218 can also be held in position by the electric transaxle housing 160 at its position toward the end of the drive shaft 210. The drive shaft 210 extends through one of the bearings 218 and into a cutout in the electric transaxle housing 160. Two rings 222 are positioned on the drive shaft 210 within annular channels defined by the drive shaft 210. The rings 222 extend radially away from the drive shaft 210 to rest against an inner circumferential surface of the cutout. The Rotation of the drive shaft 210 rotates a drive shaft 244 through engagement of a low-speed gearing assembly 226 or engagement of a high-speed gearing assembly 228 of the multiple-speed power shift transmission 154. The rotation of the drive shaft 244 then drives the differential assembly 224 to drive the wheel hubs 198 and the ground engaging members 104.

Referring also to FIGS. 6-12A, the multiple-speed power shift transmission 154 includes a first gear set 230 and the first power shift clutch 170 that when engaged provides a first speed ratio, and a second gear set 232 and the second power shift clutch 174 that when engaged provides a second speed ratio different than the first speed ratio. The first gear set 230 includes the drive shaft 210 extending along the rotation axis 206, a first large gear 234 mechanically coupled to the drive shaft 210, and a first small gear 236 mechanically coupled to the drive shaft 210 through the first power shift clutch 170. The first large gear 234 spaced along the rotation axis 206 from the first small gear 236. The drive shaft 210 extends through the first large gear 234, the first small gear 236, and the first power shift clutch 170.

The second gear set 232 includes a drive shaft 244 extending along a rotation axis 246, a second large gear 248 mechanically coupled to the drive shaft 244, and a second small gear 250 mechanically coupled to the drive shaft 244 through the second power shift clutch 174. The rotation axis 246 is parallel to the rotation axis 206. The second large gear 248 spaced along the rotation axis 246 from the second small gear 250. The second gear set 232 further includes a drive sleeve 252 inserted over the drive shaft 244. The drive sleeve 252 is mechanically coupled to the drive shaft 244 such that rotation of the drive sleeve 252 rotates the drive shaft 244. For example, the drive shaft 244 can include splines 254 that mate with splines 256 inside of the drive sleeve 252. The second large gear 248 is mechanically coupled to the drive sleeve 252 and the second small gear 250 is mechanically coupled to the drive sleeve 252 through the second power shift clutch 174. In at least one aspect, the drive sleeve 252 can include a protrusion 251 that extends radially away from the drive sleeve 252 and the second large gear 248 can couple with the protrusion 251. The drive shaft 244 and drive sleeve extend through the second large gear 248, the second small gear 250, and the second power shift clutch 174.

The drive shaft 244 and drive sleeve 252 extend through a bearing 386 held in position by the electric transaxle housing 160. The drive shaft 244 is mechanically coupled to a third gear 422 on the opposite end of the drive shaft 244 than the bearing 386. The third gear 422 rotating with the drive shaft 244. For example, the end of the drive shaft 244 can be inserted into the third gear 422 and splines on the drive shaft 244 can mesh with splines in the third gear 422. The drive shaft 244 can be held within the third gear 422 by a bolt 424. A protrusion 426 can extend away from the third gear 422 in a direction away from the drive shaft 244. The bolt 424 can be inserted inside of the protrusion 426 and be threaded into the drive shaft 244 at hole 241. The protrusion 426 can be inserted into a bearing 428. The bearing 428 is held in position by the electric transaxle housing 160. The bearings 386, 428 support the drive shaft 244 and allow the drive shaft 244 to rotate relative to the electric transaxle housing 160.

In at least one aspect, the first gear set 230 is identical to the second gear set 232 and the first gear set 230 and second gear set 232 are arranged in opposite axial orientations. The first large gear 234 is identical to the second large gear 248 and the first small gear 236 is identical to the second small gear 250. The first small gear 236 meshes with the second large gear 248 to provide the first speed ratio and the first large gear 234 meshes with the second small gear 250 to provide the second speed ratio. The second speed ratio being greater than the first speed ratio. The low-speed gearing assembly 226 includes the first small gear 236, the second large gear 248, and the first power shift clutch 170. The high-speed gearing assembly 228 includes the first large gear 234, the second small gear 250, and the second power shift clutch 174. The first and second power shift clutches 170, 174 function the same and include many of the same components. Engaging the first power shift clutch 170 and disengaging the second power shift clutch 174, causes the low-speed gearing assembly 228 to be engaged and rotate the drive shaft 244 at the first speed ratio. Disengaging the first power shift clutch 170 and engaging the second power shift clutch 174, causes the high-speed gearing assembly 228 to be engaged and rotate the drive shaft 244 at the second speed ratio.

The first large gear 234 is mechanically coupled to the drive shaft 210 such that rotation of the drive shaft 210 rotates the first large gear 234. For example, splines on the drive shaft 210 can mesh with splines of the first large gear 234 to mechanically couple the first large gear 234 to the drive shaft 210. In at least one aspect, the drive shaft 210 can include a protrusion 211 that extends radially away from the drive shaft 210 and the first large gear 234 can couple with the protrusion 211. The drive shaft 210 is mechanically coupled to the first small gear 236 through the first power shift clutch 170. As such, the first small gear 236 rotates with the drive shaft 210 when the first power shift clutch 170 is engaged and the first small gear 236 does not rotate with the drive shaft 210 when the first power shift clutch 170 is disengaged.

The second large gear 248 is mechanically coupled to the drive shaft 244 such that rotation of the drive shaft 244 rotates the second large gear 248. For example, splines on the drive shaft 244 can mesh with splines of the second large gear 248 to mechanically couple the second large gear 248 to the drive shaft 244. The drive shaft 244 is mechanically coupled to the second small gear 250 through the second power shift clutch 174. As such, the second small gear 250 rotates with the drive shaft 244 when the second power shift clutch 174 is engaged and the second small gear 250 does not rotate with the drive shaft 244 when the second power shift clutch 174 is disengaged.

The first large gear 234 is mechanically coupled with the second small gear 250, for example, gear teeth 258 of the first large gear 234 are meshed with gear teeth 260 of the second small gear 250. As such, rotation of the first large gear 234 causes the second small gear 250 to rotate and vice versa. The first small gear 236 is mechanically coupled with the second large gear 248, for example, gear teeth 262 of the first small gear 236 are meshed with gear teeth 264 of the second large gear 248. As such, rotation of the first small gear 236 causes the second large gear 248 to rotate and vice versa. Regarding the high-speed gearing assembly 228, the first large gear 234 is larger than the second small gear 250. As such, when the second power shift clutch 174 is engaged and the first power shift clutch 170 is disengaged, the drive shaft 244 rotates faster than drive shaft 210. Regarding the low-speed gearing assembly 228, the first small gear 236 is smaller than the second large gear 248. As such, when the second power shift clutch 174 is disengaged and the first power shift clutch 170 is engaged, the drive shaft 244 rotates slower than the drive shaft 210. Engaging the high-speed gearing assembly 228 causes the drive shaft 244 to rotate faster than engaging the low-speed gearing assembly 226.

The first large gear 234 and the second large gear 248 are identical. The first small gear 236 and the second small gear 250 are identical. Engaging the first power shift clutch 170 can cause the speed of the drive shaft 244 to step up by a specific amount; and engaging the second power shift clutch 174 can cause the speed of the drive shaft 244 to step down by the same specific amount. The desired increase or decrease in rotation speed can be determined by the size of the first gears 234, 236 and the second gears 250, 248, respectively.

When the second power shift clutch 174 is engaged and first power shift clutch 170 is disengaged, the first small gear 236 will rotate based on the rotate of the second large gear 248 caused by the rotation of the drive shaft 244. This rotation of the second large gear 248 will not affect the rotation of the drive shaft 244 or drive shaft 210. When the second power shift clutch 174 is disengaged and first power shift clutch 170 is engaged, the second small gear 250 will rotate based on the rotate of the first large gear 234 caused by the rotation of the drive shaft 210. This rotation of the second small gear 250 will not affect the rotation of the drive shaft 244 or drive shaft 210.

During powershifting from the low-speed gearing to the high-speed gearing, the first power shift clutch 170 will be disengaging while the second power shift clutch 174 is engaging. To perform a smooth transition, the power shift clutches 170, 174 will both be slightly engaged for a brief amount of time where the power shift clutches 170, 174 will slip to maintain a smooth rotation speed of the drive shaft 244. While the two power shift clutches 170, 174 are slightly engaged, the rotation and torque of the drive shaft 244 is being supplied by both the high-speed gearing and the low-speed gearing, while each gearing is slipping to some degree. Slipping is required to allow the smooth transition between the gearing systems without requiring stopping or 100 percent synchronous shifting. Smooth rotation of the drive shaft 244 during the power shifting relates to a smooth speed and movement of the work vehicle. Similarly, slipping of the two power shift clutches 170, 174 also occurs during powershifting from the high-speed gearing to the low-speed gearing.

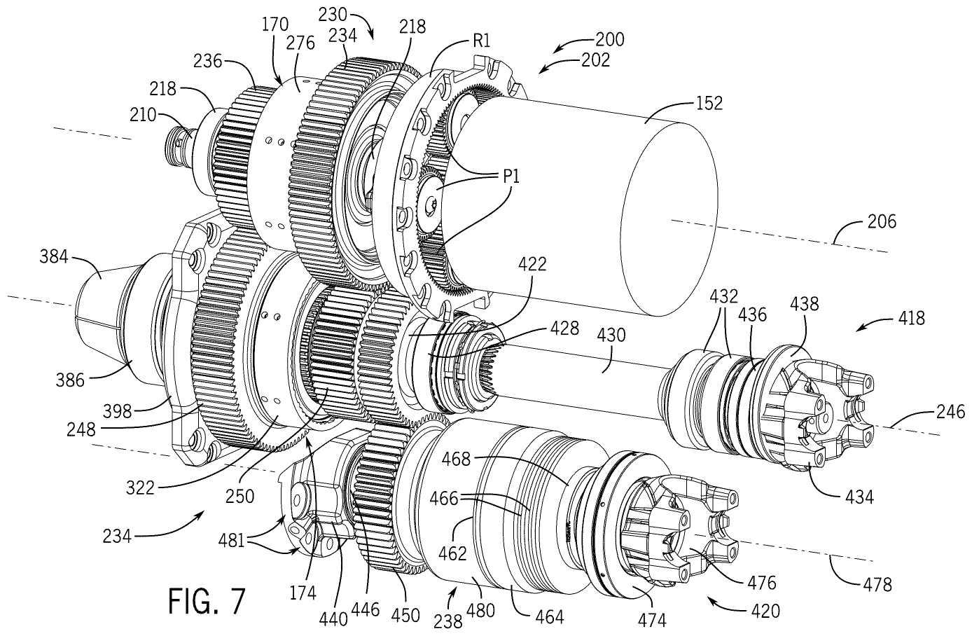

The first power shift clutch 170 will be described in detail and the description also applies to the second power shift clutch 174. Referring also to FIGS. 7-12A, the first power shift clutch 170 includes a clutch pack 266, an actuator piston 268, a return spring 281, an end stop 270, a first snap ring 272, a second snap ring 274, a spring stop 280, a thrust washer 292, and a clutch ring 276. The clutch pack 266 is positioned between a protrusion 278 of the of the first small gear 236 and the clutch ring 276. The clutch pack 266 meshes with the clutch ring 276 and the protrusion 278. The control system 120 controls the valves 242 on the oil manifold 180 to supply hydraulic fluid to cause the actuator piston 268 to translate along the rotation axis 206 and compress/decompress the clutch pack 266 which engages/disengages the first power shift clutch 170. When the first power shift clutch 170 is engaged, the first small gear 236 rotates with the first power shift clutch 170, and when the clutch assembly is disengaged, the first small gear 236 is no longer coupled to rotate with the first power shift clutch 170.

The clutch pack 266 includes a plurality of first members 282 and a plurality of second members 284. The clutch pack 266 is formed by alternating the placement of the first members 282 and second members 284 such that the first members 282 are placed adjacent to second members 284 and the second members 284 are placed adjacent to first members 282. In at least one aspect, the surfaces of the second members 284 facing the first members 282 and the surfaces of the first members 282 facing the second members 284 are all rough surfaces. A friction force is formed between the first members 282 and second members 284 when a compression force is applied to the clutch pack 266. The compression force biases the first members 282 and second members 284 toward each other. The compression force has a direct relationship with the friction force between the first members 282 and the second members 284, whereas the compression force increases the friction force increases and as the compression force decreases the friction force decreases.

Increasing the compression force engages the clutch pack 266. As the compression force increases, the friction force will increase to be greater than a first threshold and the clutch pack 266 begins to engage transmitting torque through the clutch pack 266. When the clutch pack 266 begins to engage the first members 282 and the second members 284 can slip against one another. The slipping allows only a portion of the total torque to be transmitted through the clutch pack 266. As the compression force continues to increase the friction force will eventually be greater than a second threshold value, where the clutch pack 266 is fully engaged. When the clutch pack 266 is fully engaged, the first members 282 and the second members 284 will no longer slip against each other and rotate together. Additionally, in the fully engaged position, the clutch pack 266 will transfer the full torque through the clutch pack 266. In at least one aspect, the threshold value can change based on the terrain (e.g., moving uphill, moving downhill, moving over rough terrain, moving through muddy terrain, etc.) and operation of the work vehicle (e.g., overall weight of the work vehicle, speed the work vehicle is moving, etc.) and forces being applied to the ground engaging members. As the compression force is decreased, the friction force will decrease to below the second threshold, where the clutch pack 266 can slip, and then below the first threshold where the clutch pack 266 is disengaged. When the clutch pack 266 is disengaged, the first members 282 and the second members 284 can rotate differently about the rotation axis 206 and no torque is transmitted through the clutch pack 266.

The first members 282 and the second members 284 are discs (e.g., friction discs/plates). The first members 282 include inner teeth 286 on the inner circumference of the first members 282. The second members 284 include outer teeth 288 on the outer circumference of the second members 284. The clutch pack 266 can be position outside of a first component and inside of a second component. The inner teeth 286 can mate with the first component and the outer teeth 288 can mate with the second component. When the clutch pack 266 is engaged the first component and the second component would be linked through the clutch pack 266 transmitting torque from the first or second component to the other component. Additionally, when the clutch pack 266 is fully engaged, the first component and the second component rotate together. When the clutch pack 266 is disengaged, the first component and the second component are no longer linked and can rotate differently relative to each other without transmitting torque through the clutch pack 266.

The first large gear 234, the first small gear 236, and each component 266, 268, 270, 272, 274, 276, 280, 292, 281 of the first power shift clutch are axially aligned with the rotation axis 206 and positioned along the drive shaft 210. The drive shaft 210 extends through a hole 304 defined in the first small gear 236. The hole 304 extends through the protrusion 278 and through the entire first small gear 236. Two bearings 294 are positioned between the first small gear 236 and the drive shaft 210. The bearings 294 allow the first small gear 236 to rotate relative to the drive shaft 210. A first bearing 294 is positioned against a protrusion 302 inside of the hole and against the drive shaft 210. The protrusion 302 extending toward the rotation axis 206. The drive shaft 210 is shaped to have different diameters along the drive shaft 210. The bearing 294 is positioned on the drive shaft 210 at one diameter and rests against a portion of the drive shaft 210 with a larger diameter. A snap ring 298 is positioned in a channel located inside of the inner circumference of the first small gear 236. The snap ring 298 holds the bearing 294 in position. A spacer 296 is positioned between the two bearings 294 with each bearing 294 resting against the spacer 296. A snap ring 300 is positioned in a channel in the drive shaft 210. The snap ring 300 holds the second bearing 294 in position against the spacer 296, the spacer 296 against the other bearing 294, and the other bearing 294 against the portion of the drive shaft 210 with a larger diameter.

The actuator piston 268 is positioned against the opposite end of the first small gear 236 from the bearings 294. The actuator piston 268 is positioned between the first small gear 236 and the first large gear 234. The actuator piston 268 extends into the hole 304 in the protrusion 278. The actuator piston 268 includes a protrusion 306 that extends away from the rotation axis 206. The protrusion 306 is positioned within a hole 308 of the first large gear 234. The protrusion 306 extends to reach the inner circumference of the hole 308. The diameter of the protrusion 306 is larger than the diameter of the protrusion 278 of the first small gear 236. The protrusion 306 defines a cutout 310 in the protrusion 306 extending along the rotation axis 206 away from the first small gear 236. The cutout 310 allows the protrusion 306 of the actuator piston 268 to reach around the protrusion 278 of the first small gear 236. As such, when the actuator piston 268 is translated toward the first small gear 236, the protrusion 278 enters the cutout 310 and the protrusion 306 reaches the clutch pack 266 to be able to compress the clutch pack 266.

The protrusion 306 can engage the clutch pack 266 by compressing the clutch pack 266 between the protrusion 306 and the end stop 270. The end stop 270 is mated with the clutch ring 276. For example, the end stop 270 can include gear teeth 312 that are meshed with splines 290 on an inner circumferential surface of the clutch ring 276. A snap ring 272 is positioned in a channel in the clutch ring 276. The snap ring 272 is to keep the end stop 270 from sliding out of the clutch ring 276. For example, when the protrusion 306 compresses the clutch pack 266 against the end stop 270, the end stop 270 rests against the snap ring 272. The snap ring 272 holds the end stop 270 in position for the compression of the clutch pack 266. The inner circumference of the end stop 270 rests against a ring 314. The ring 314 rests in a cutout 316 of the first small gear 236. The ring 314 acts as a spacer between the first small gear 236 and the end stop 270.

The inner teeth 286 of the first members 282 of the clutch pack 266 mate with the protrusion 278 of the first small gear 236. For example, the protrusion 278 can include splines 291 on an outer circumference that mesh with the inner teeth 286. As such, rotation of the first small gear 236 will rotate the first members 282 and vice versa. The outer teeth 288 of the second members 284 of the clutch pack 266 can mate with the clutch ring 276. For example, the splines 290 of the clutch ring 276 can mesh with the outer teeth 288. As such, rotation of the clutch ring 276 will rotate the second members 284 and vice versa.

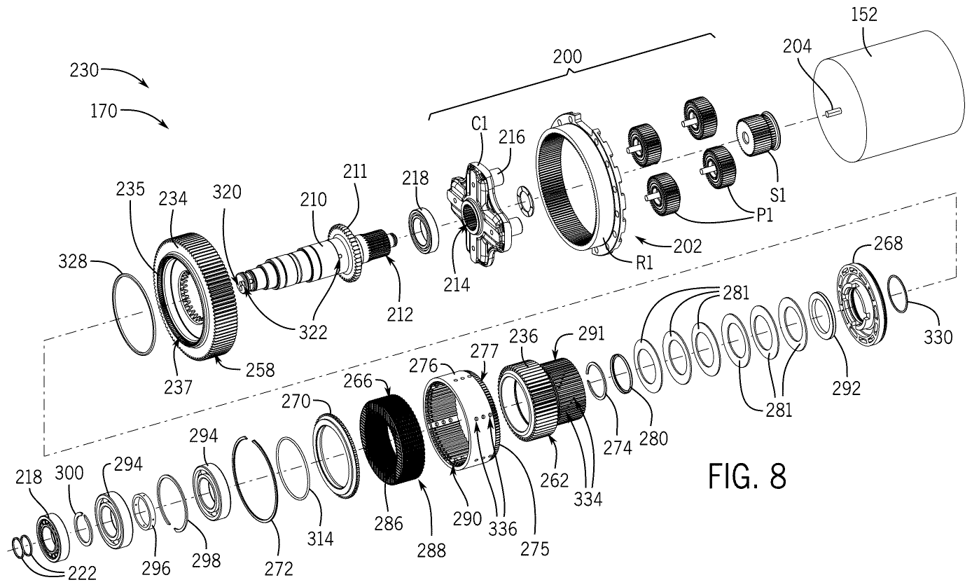

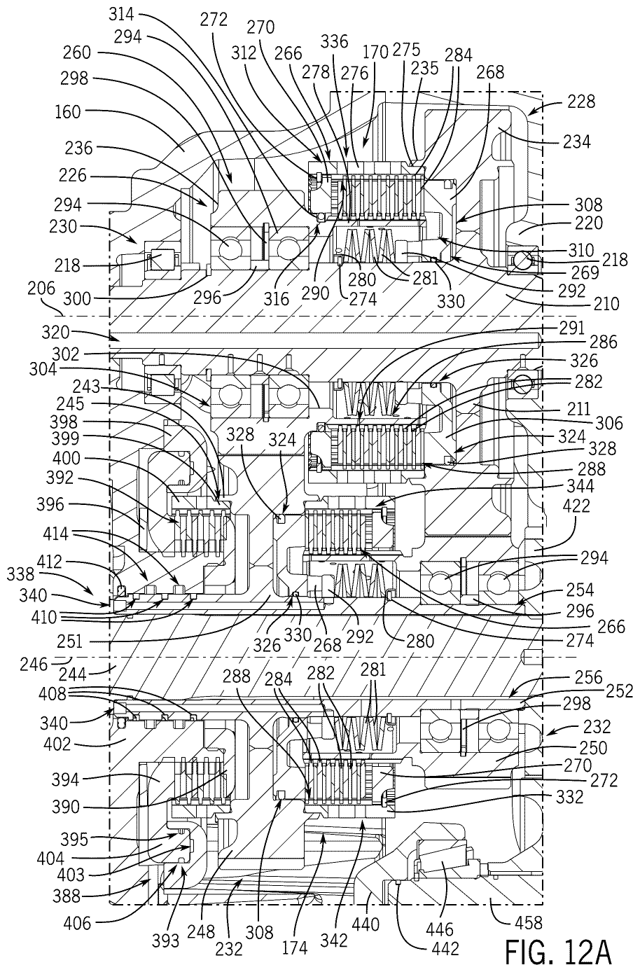

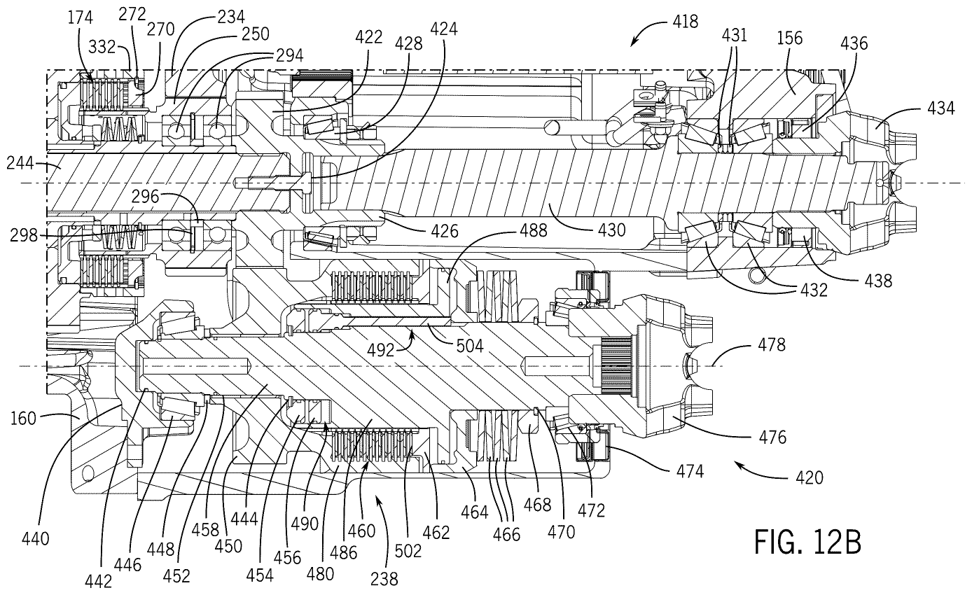

Referring also to FIGS. 8 and 12A, the clutch ring 276 includes an annular protrusion 275 extending toward the first large gear 234. The first large gear 234 includes an annular protrusion 235 extending toward the clutch ring 276. The annular protrusion 275 rests within the annular protrusion 235 and the annular protrusion 275 mechanically couples with annular protrusion 235 such that the first large gear 234 and the clutch ring 276 rotate together. For example, splines 277 positioned on the outer surface of annular protrusion 275 can mesh with splines 237 positioned on the inner surface of annular protrusion 235. As discussed previously, the first large gear 234 is mechanically coupled to the drive shaft 210 and rotates with the drive shaft 210. The clutch ring 276 also rotates with the drive shaft 210 since the clutch ring 276 is mechanically coupled to the first large gear 234 and rotates with the first large gear 234.

The actuator piston 268 compresses the clutch pack 266 and engages the clutch pack 266. When the clutch pack 266 is fully engaged, the clutch ring 276, and first small gear 236 rotate together. As such, the clutch ring 276, first small gear 236, first large gear 234, and drive shaft 210 all rotate together. When the clutch pack 266 is fully engaged, the power from the drive shaft 210 goes through the first large gear 234 then through the first power shift clutch 170 to provide rotational power to the first small gear 236. When the clutch pack 266 is disengaged, the first small gear 236 no longer has to rotate with the drive shaft 210 and the first small gear 236 free to rotate differently than the drive shaft 210. For example, in the disengaged position, the clutch ring 276, the first large gear 234, and the drive shaft 210 rotate together and the first small gear 236 is not driven through the clutch pack 266 of the first power shift clutch 170.

The first power shift clutch 170 is engaged and disengaged by hydraulic fluid and released by a spring (e.g., return spring 281). As such the first power shift clutch 170 is hydraulically applied and spring released. Hydraulic fluid is used to cause the actuator piston 268 to translate along the drive shaft 210 towards the first small gear 236. The control system 120 controls the valves 242 on the oil manifold 180 to supply hydraulic fluid to cause the actuator piston 268 to translate along the rotation axis 206 to compress and engage the clutch pack 266. The hydraulic pump 164 pumps the hydraulic fluid at a pressure through the hydraulic circuit. The hydraulic circuit includes passageways inside of the outer wall of the electric transaxle housing 160. For example, a passageway in the outer wall of the electric transaxle housing 160 allows the hydraulic fluid to flow from the manifold 180 and to the end 318 of the drive shaft 210. A valve 242 is controlled by the control system 120 to control the flow of hydraulic fluid into this passageway. The hydraulic fluid can then travel through a passageway 320 in the drive shaft 210 where this passageway 320 allows the hydraulic fluid to lubricate and cool the different components (e.g., components 218, 294, 296, 292) resting on the drive shaft 210. The hydraulic fluid can also travel through passageway 322 in the drive shaft 210 to reach the actuator piston 268.

The actuator piston 268 defines an outer annular channel 324 on the protrusion 306 and an inner annular channel 326 on an inner surface of the actuator piston 268. An outer sealing ring 328 is positioned within the outer annular channel 324 to seal the gap between the protrusion 306 and the first large gear 234. An inner sealing ring 330 is positioned within the inner annular channel 326 to seal any gaps between the actuator piston 268 and the drive shaft 210. The passageway 322 allows hydraulic fluid to enter the space 269 between the actuator piston 268 and the first large gear 234 that is sealed by the sealing rings 328, 330. The hydraulic fluid enters this space and fills the space. As more hydraulic fluid enters the space, the pressure from the hydraulic fluid creates an actuation force that causes the actuator piston 268 to translate along the drive shaft 210 toward the first small gear 236. The translation of the actuator piston 268 toward the first small gear 236 causes the protrusion 306 to contact the clutch pack 266 and engage the clutch pack 266.

The translation of the actuator piston 268 toward the first small gear 236 compresses a return spring 281. The return spring 281 applies a biasing force against the actuator piston 268 in a direction along the rotation axis 206 away from the first small gear 236. As such, to move the protrusion 306 toward the clutch pack 266, the actuation force applied to the actuator piston 268 must be greater than the biasing force of the return spring 281 applied to the actuator piston 268. Once the actuation force has increased to above a threshold value, the actuation piston 464 will have moved enough to compress the clutch pack 266 between the protrusion 306 and the end stop 270 to cause the clutch pack 266 to engage. For example, the as the hydraulic fluid pressure builds the actuation force increases and the protrusion 306 will begin compressing the clutch pack 266 causing the clutch pack 266 to slip and then fully engage as the first members 282, second members 284, and actuator piston 268 contact each other with enough force to rotate together. Upon fully engaging the clutch pack 266, the actuator piston 268, drive shaft 210, and the first small gear 236 will all rotate together.

The control system 120 can control a valve 242 to decrease the hydraulic fluid flow into the passageway 322 decreasing the hydraulic fluid pressure and thus decreasing the actuator force caused by the hydraulic fluid pressure. For example, as the hydraulic fluid pressure decreases some hydraulic fluid can flow back out of the passageway 322 and into the passageway 320 to decrease the hydraulic fluid pressure and hydraulic fluid in the space sealed between the actuator piston 268 and first large gear 234. Once the actuation force caused by the hydraulic fluid pressure decreases to be less than the biasing force of the return spring 281, the return spring 281 will bias the protrusion 306 away from the clutch pack 266 disengaging the clutch pack 266. As the actuation piston 268 translates away from the first small gear 236, the hydraulic fluid in the space between the actuation piston 268 and the first large gear 234 can be pushed out of the passageway 322 by the return spring 281 biasing force and into the passageway 320. As the actuation force decreases the first members 282 and second members 284 will contact each other with less force until the clutch pack 266 begins to slip and then fully disengages as the protrusion 306 moves away.

When the actuator piston 268 moves toward the first small gear 236, the actuator piston 268 pushes the thrust washer 292 into the return spring 281 to compress the return spring 281 between the thrust washer 292 and spring stop 280. A snap ring 274 is position in an annular channel in the drive shaft 210. The snap ring 274 holds the spring stop in position when the return spring 281 is compressed. In at least one aspect, the return spring 281 is one or more compression springs (e.g., one or more bevel springs). Hydraulic fluid can enter the space within the first small gear 236 where the return spring 281 is positioned. The hydraulic fluid can exit the first small gear 236 through holes 334 to reach the clutch pack 266 and then exit out the clutch ring 276 through holes 336. This hydraulic fluid can cool the clutch pack 266, return spring 281, first small gear 236, and clutch ring 276.

The second large gear 248, the second small gear 250, and the second power shift clutch 174 are substantially similar and function the same as the first large gear 234, the first small gear 236, and the first power shift clutch 170. For the sake of brevity the similarities between them will not be discussed in detail. The second large gear 248, the second small gear 250, and each component 266, 268, 270, 272, 274, 276, 280, 292, 281 of the second power shift clutch 174 are axially aligned with the rotation axis 246 and positioned along the drive shaft 244. The second large gear 248 and the second small gear 250 are arranged in opposite axial orientations than the first large gear 234 and the first small gear 236. As discussed previously, this opposite axial orientation allows the second large gear 248 to mesh with the first small gear 236 and the second small gear 250 to mesh with the first large gear 234.

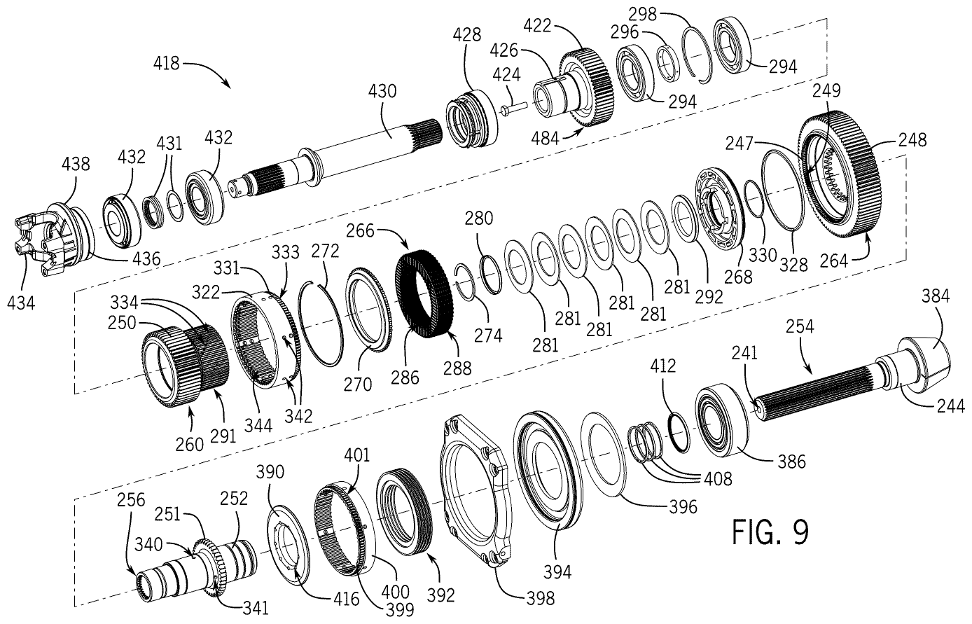

The second large gear 248, the second power shift clutch 174, and the second small gear 250 are positioned on the drive sleeve 252. Hydraulic fluid is used to cause the actuator piston 268 to translate along the drive sleeve 252 towards the second small gear 250. The control system 120 controls the valves 242 on the oil manifold 180 to supply hydraulic fluid to cause the actuator piston 268 to translate along the rotation axis 246 to compress and engage the clutch pack 266. The hydraulic pump 164 pumps the hydraulic fluid at a pressure through the hydraulic circuit. The hydraulic circuit includes passageways inside of the outer wall of the electric transaxle housing 160. For example, a passageway in the outer wall of the electric transaxle housing 160 allows the hydraulic fluid to flow from the manifold 180 and to the end 338 of the drive shaft 244. A valve 242 is controlled by the control system 120 to control the flow of hydraulic fluid into this passageway. The hydraulic fluid can then travel through passageways 340 and passageways 341 (FIG. 9) in the drive sleeve 252 to reach the actuator piston 268. There are two passageways 340 and two passageways 341 with the passageways 340, 341 spaced equally around the rotation axis 246. The passageways 341 are similar to passageways 340. The passageways 341 allow hydraulic fluid to enter the space between the actuator piston 268 and the second large gear 248 that is sealed by the sealing rings 328, 330. The hydraulic fluid enters this space and fills the space. As more hydraulic fluid enters the space, the pressure from the hydraulic fluid creates an actuation force that causes the actuator piston 268 to translate along the drive sleeve 252 toward the second small gear 250. The translation of the actuator piston 268 toward the second small gear 250 causes the protrusion 306 to contact the clutch pack 266 and engage the clutch pack 266.

The second power shift clutch 174 is the same as the first power shift clutch 170 with the second power shift clutch 174 having a different clutch ring 332. Similar to clutch ring 276, clutch ring 332 in mated with the second members 284. For example, the clutch ring 332 can include splines 344 that mesh with the outer teeth 288. As such, rotation of the clutch ring 332 will rotate the second members 284 and vice versa. Similar to clutch ring 276, the end stop 270 is meshed with the clutch ring 332, the snap ring 272 is position in a channel within the clutch ring 332, and the clutch ring 332 includes holes 342 that allow hydraulic fluid to pass through the clutch ring 332.

Referring also to FIGS. 9 and 12A, the clutch ring 332 includes an annular protrusion 331 extending toward the second large gear 248. The second large gear 248 includes an annular protrusion 247 extending toward the clutch ring 332. The annular protrusion 331 rests within the annular protrusion 247 and the annular protrusion 331 mechanically couples with annular protrusion 247 such that the second large gear 248 and the clutch ring 332 rotate together. For example, splines 333 positioned on the outer surface of annular protrusion 331 can mesh with splines 249 positioned on the inner surface of annular protrusion 247. As discussed previously, the second large gear 248 is mechanically coupled to the drive shaft 244 through drive sleeve 252 and rotates with the drive shaft 244. The clutch ring 332 also rotates with the drive shaft 244 since the clutch ring 332 is mechanically coupled to the second large gear 248 and rotates with the second large gear 248.

Regarding the second power shift clutch 174, the actuator piston 268 compresses the clutch pack 266 and engages the clutch pack 266. When the clutch pack 266 is fully engaged, the clutch ring 332 and second small gear 250 rotate together. As such, the clutch ring 332, second small gear 250, second large gear 248, drive sleeve 252, and drive shaft 244 all rotate together. When the clutch pack 266 is fully engaged, the power from the drive shaft 244 goes through the drive sleeve 252 then through the second large gear 248 then through the second power shift clutch 174 to provide rotational power to the second small gear 250. When the clutch pack 266 is disengaged, the second small gear 250 no longer has to rotate with the drive shaft 244 and the second small gear 250 is free to rotate differently than the drive shaft 244. For example, in the disengaged position, the clutch ring 332, the second large gear 234, the drive sleeve 252, and the drive shaft 244 rotate together and the second small gear 250 is not driven through the clutch pack 266 of the second power shift clutch 174. The second power shift clutch 174 is engaged and disengaged by hydraulic fluid and released by a spring (e.g., return spring 281) the same as the first power shift clutch 170. As such the second power shift clutch 174 is hydraulically applied and spring released.

The control system 120 can control a valve 242 to decrease the hydraulic fluid flow into the passageways 340 decreasing the hydraulic fluid pressure and thus decreasing the actuator force caused by the hydraulic fluid pressure. Once the actuation force caused by the hydraulic fluid pressure decreases to be less than the biasing force of the return spring 281, the return spring 281 will bias the protrusion 306 away from the clutch pack 266 disengaging the clutch pack 266. As the actuation piston 268 translates away from the second small gear 250, the hydraulic fluid in the space between the actuation piston 268 and the second large gear 248 can be pushed out of the passageways 340 by the return spring 281 biasing force. As the actuation force decreases the first members 282 and second members 284 will contact each other with less force until the clutch pack 266 begins to slip and then fully disengages as the protrusion 306 moves away.

It is important that the clutch packs 266 can slip to allow for a smooth transition of torque from one gearing system 226, 228 to another during power shifting. Power shifting is to shift from the high-speed gearing assembly 228 or the low-speed gearing assembly 226 to the other while the work vehicle 100 is moving. During the shifting process, the clutch packs 266 slip as one clutch pack 266 begins engaging and the other clutch pack 266 begins disengaging. During this slipping period, the high-speed gearing assembly 228 and the low-speed gearing assembly 226 both supply torque from the drive shaft 210 to the drive shaft 244. The amount of torque supplied by each gearing assembly 226, 228 changes as the gearing assemblies 226, 228 become more engaged or disengaged. As a gearing assembly 226, 228 becomes more engaged the amount of torque supplied by that gearing assembly 226, 228 increases until it reaches the fully engaged position. As a gearing assembly 226, 228 becomes more disengaged the amount of torque supplied by that gearing assembly 226, 228 decreases until it reaches the fully disengaged position. The power shift clutches 170, 174 move to the fully disengaged position and fully engaged position to transition from one gearing assembly 226, 228 driving the drive shaft 244 to the other driving the drive shaft 244. For example, engaging the first power shift clutch 170 and disengaging the second power shift clutch 174, causes the low-speed gearing assembly 228 to be engaged and provide power to the drive shaft 244 at the first speed ratio. Disengaging the first power shift clutch 170 and engaging the second power shift clutch 174, causes the high-speed gearing assembly 228 to be engaged and provide power at the drive shaft 244 at the second speed ratio.

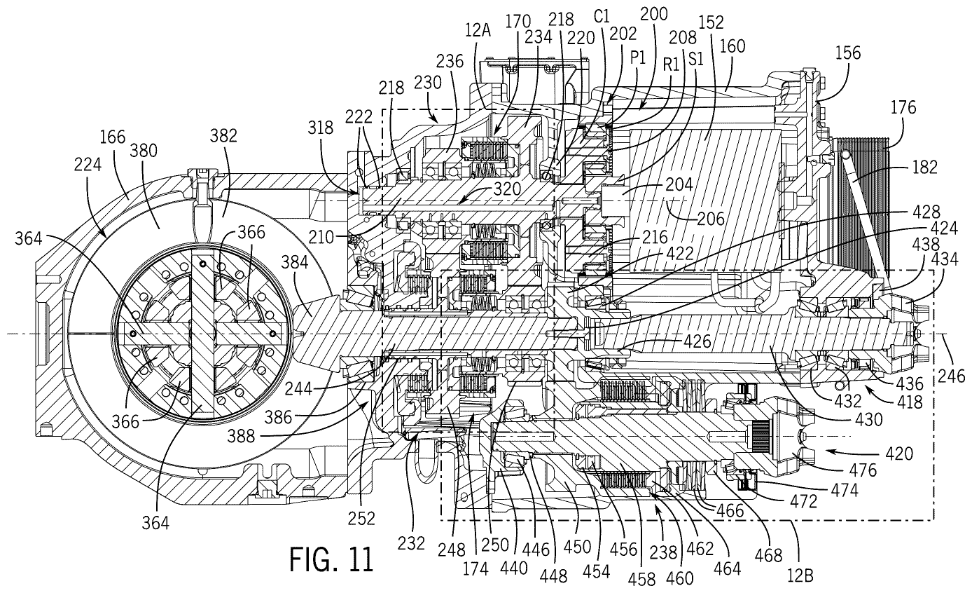

Referring also to FIG. 11, the drive sleeve 252 and drive shaft 244 extend into a protrusion 402 in the electric transaxle housing 160. The drive sleeve 252 includes three annular channels positioned on the drive sleeve 252 within the protrusion 402. Three rings 408 are positioned within the annular channels 410 with one ring 408 being positioned in each channel. The rings 408 extending away from the drive sleeve 252 and contacting an inner circumferential surface of the protrusion 402. The drive sleeve 252 extends through a seal 412 positioned at the end of the drive sleeve 252. The seal 412 positioned within an annular channel within the electric transaxle housing. The drive shaft 244 extends further than the drive sleeve 252, the drive shaft 244 entering the differential housing 166.

Referring still to FIG. 11, the drive shaft 244 drives the differential assembly 224 to drive the wheel hubs 198 and the ground engaging members 104. In an alternative aspect, a longer or shorter wheel hub 198 is possible by shortening or extending the length of the wheel hub 198 and outer casing 346. The hubs 198 are elongated members extending through the outer casings 346 of the wheel end units 196 and rotationally supported by one or more bearings 348 at each laterally inner and outer end so as to rotate about a wheel axis 350, about which the ground-engaging members 104 rotate during travel of the work vehicle 100. The elongated hubs 198 couple to a final drive 351. The final drives 351 include a final reduction gear set 352 and a shaft 354. The laterally inner ends of the elongated hubs 198 couple to the final reduction gear sets 352. Each final reduction gear set 352 may be embodied as a planetary gear set. However, other types of reduction drives may also be used. In the depicted embodiment, the laterally inner end of each elongated hub 198 is splined or toothed to engage with the splines or teeth of a planet carrier C2. The carrier C2 has pinions that rotatably mount planetary gears P2 (e.g., two, three or more), which are positioned in the annular space between a ring gear R2, which is formed in or fixed relative to the casing of the wheel end unit 196, and a sun gear S2 to mesh with both the ring gear R2 and the sun gear S2. The sun gear S2 is rigidly coupled to a shaft 354 to co-rotate as one unit about the wheel axis 350. Recesses in the laterally outer ends of the shafts 354 accommodate the heads of bolts 356 threaded into the inner ends of the elongated hubs 198 to secure retainer plates 349 in abutment with the carriers C2, and thereby retain the elongated hubs 198 to the carriers C2 for co-rotation therewith. The illustrated final reduction gear sets 352 provides sun-in, carrier-out-type power flow planetary arrangements that effect a deep gear reduction ratio between the power input to the wheel end units 196 and the power output from the wheel end units 196 to the ground-engaging members 104.

Referring also to FIG. 11, the laterally inner end of shaft 354 of each final reduction gear set 352 extends into a differential assembly 224 that rotates about the wheel axis 350, relative to the wheel end casings 346 and the differential housing 166. In the illustrated example, the differential assembly 224 includes a differential casing 358 that rotates on bearings 360 relative to mounting collars 362 coupled to the wheel end casings 346. The differential casing 358 defines an interior cavity in which are disposed differential pinions 364 and pinion gears 366. In the illustrated example there are four differential pinions 364 mounting four pinion gears 366. The differential pinions 364 intersect at right angles and are arranged orthogonal to the wheel axis 350, with their ends fit into recesses in the interior of the differential casing 358. The differential pinion gears 366 engage two side gears 368, 370 positioned on opposite sides of the differential assembly 224 and rigidly fixed (e.g., press-fit or keyed) to the laterally inner ends of the shafts 354. The differential pinion gears 366 and the side gears 368, 370 are embodied as bevel gears such that axes of rotation thereof are perpendicular. As will be understood, the differential assembly 224 enables rotation of the side gears 368, 370 at different speeds, and thereby, to allow the elongated hubs 198 of the wheel end units 196 to drive the ground-engaging members 104 at different rotational speeds.

In the depicted embodiment, the differential assembly 224 can be locked by a brake 372. The brake 372 may be activated electro-hydraulically, through the operator interface 124 via the control system 120, by moving a piston 376 into engagement with the brake 372. The brake 372 has a pack 374 of alternately interleaved plates and friction discs that are alternately splined to the differential casing 358 and an annular hub 378 of the side gear 368. Engaging the brake 372 causes the side gear 368 to co-rotate with the differential casing 358, and in so doing, causes the differential pinions 364 and pinion gears 366 to co-rotate the side gear 370 with the side gear 368 and the differential casing 358. This effectively “locks” the differential assembly 224 such that both shafts 354 and the elongated hubs 198 also co-rotate together. This, in turn, locks the left and right ground-engaging members 104 to co-rotate together at the same speed, in the manner of a fixed axle.

As shown in FIGS. 11 and 12A, power from the drive shaft 244 is coupled to the differential assembly 224, and thereby the wheel end units 196, through a drive gear 380. The drive gear 380 is rigidly coupled to the differential casing 358 to co-rotate therewith about the wheel axis 350. The drive gear 380 is configured with an annular beveled face 382 defining teeth of any suitable configuration, and which, in the depicted example, are spherical bevel teeth. The drive shaft 244 extends through the bearing 386 and into the differential assembly 224. The drive shaft 244 includes an output gear 384 meshing with the teeth of the annular beveled face 382 of the drive gear 380. In at least one aspect, the output gear 384 is a spiral bevel gear meshing with the annular beveled face 382 of the drive gear 380. When the first power shift clutch 170 is engaged and the second power shift clutch 174 is disengaged, the output gear 384 outputs power at the first speed ratio. When the first power shift clutch 170 is disengaged and the second power shift clutch 174 is engaged, the output gear 384 outputs power at the second speed ratio. The rotation of the drive shaft 244 causes the drive gear 380 to rotate which in turn rotates the wheel end units 196 and the rear ground engaging members 104 attached to the wheel end units 196.

The electric transaxle 150 includes a parking brake assembly 388. The parking brake assembly 388 functions as a spring applied hydraulically released brake. The parking brake assembly 388 includes a brake actuator 394, a brake pack 392, a brake stop 390, a compression spring 396, a mounting ring 398, and a brake ring 400. The brake pack 392 includes alternately interleaved plates and friction discs that are alternately splined to the brake ring 400 and the protrusion 402 of the electric transaxle housing 160. The brake stop 390 is attached to the protrusion 402. For example, the brake stop 390 can be threaded into protrusion 402. The brake pack 392 rests against the brake stop 390.

Referring also to FIGS. 9 and 12A, the brake ring 400 includes an annular protrusion 399 extending toward the second large gear 248. The second large gear 248 includes an annular protrusion 243 extending toward the brake ring 400. The annular protrusion 399 rests within the annular protrusion 243 and the annular protrusion 399 mechanically couples with annular protrusion 243 such that the second large gear 248 and the brake ring 400 rotate together. For example, splines 401 positioned on the outer surface of annular protrusion 399 can mesh with splines 245 positioned on the inner surface of annular protrusion 243. As discussed previously, the second large gear 248 is mechanically coupled to the drive shaft 244 through drive sleeve 252 and rotates with the drive shaft 244. The brake ring 400 also rotates with the drive shaft 244 since the brake ring 400 is mechanically coupled to the second large gear 248 and rotates with the second large gear 248. As such, engaging the brake pack 392 creates a friction force that prevents the brake ring 400 and therefore the drive shaft 244 from rotating. Engaging and disengaging the brake pack 392 functions similar to the clutch pack 266, where compression of the brake pack 392 causes members within the brake pack 392 to compress together and slip before becoming fully engaged. Since the drive shaft 244 is used to drive the ground engaging members 104, engaging the brake pack 392 can prevent the work vehicle 100 from moving.

The mounting ring 398 bolts to the electric transaxle housing 160. The brake actuator 394 includes a protrusion 404 at the outer end that rests inside a cutout 406 in the mounting ring 398. The brake actuator 394 includes a protrusion 404 at the outer end that rests inside an annular cutout 406 in the mounting ring 398. The protrusion 404 can translate within the annular cutout 406. The protrusion 404 further includes an outer annular channel 393 and an inner annular channel 395. A sealing ring is positioned within the outer annular channel 393 and the inner annular channel 395 to seal the protrusion 404 against the annular cutout 406.

The compression spring 396 biases the inner end of the brake actuator 394 toward the brake pack 392 to engage the brake pack 392. For example, the biasing force from the compression spring 396 causes the brake actuator 394 to translate within the cutout 406 to move the brake actuator 394 toward the brake pack 392 to engage the brake pack 392. Hydraulic fluid can be used to disengage the brake pack 392. For example, hydraulic fluid can be pumped into space 403 between the mounting ring 398 and the brake actuator 394. The pressure of the hydraulic fluid within space 403 causes the brake actuator 394 to translate within the cutout 406 to move the brake actuator 394 away from the brake pack 392 to disengage the brake pack 392.

The parking brake assembly 388 can be engaged or disengaged by the control system 120. For example, the operator can use the operator interface 124 to engage or disengaged the parking brake assembly 388. The control system 120 controls the valves 242 to direct hydraulic fluid in the hydraulic circuit to supply hydraulic fluid to engage/disengaged the parking brake assembly 388 and lubricate components of the parking brake assembly 388. As such, where the operator engages the parking brake assembly 388, the control system 120 controls the valves 242 to direct hydraulic fluid into the space 403 to build pressure there to translate the brake actuator 394 away from the brake pack 392. To move the brake actuator 394 away from the brake pack 392, the pressure of the hydraulic fluid must produce a force greater than the biasing force produced by the compression spring 396. When the operator disengages the parking brake assembly 388, the control system 120 controls the valves 242 to decrease the hydraulic pressure in the space 403 causing the compression spring 396 to translate the brake actuator 394 toward the brake pack 392.

Additionally, the passageways 414 are part of the hydraulic circuit within the electric transaxle housing 160 to direct hydraulic fluid to the parking brake assembly 388. The passageways 414 direct the hydraulic fluid to the brake stop 390 to pass through holes 416 to lubricate the drive sleeve 252 and components of the parking brake assembly 388. The brake ring 400 includes holes to allow hydraulic fluid to enter and exit the brake ring 400.

The electric transaxle further includes one or more power take off assemblies that are driven by the drive shaft 244. Each power take off assembly is mounted to or contained at least in part within the electric transaxle housing 160. The power take off assemblies are each configured to receive power from the multiple-speed power shift transmission at the first speed ratio or the second speed ratio. In some aspects, the power take off assemblies can also transmit power to the multiple-speed power shift transmission at the first speed ratio or the second speed ratio. The power take off assemblies can be mechanically coupled to drive the front ground engaging members 104. For example, one of the power take off assemblies can be used to drive the front ground engaging members 104 through a front differential assembly that functions similar to the differential assembly 224. In the depicted embodiment, there are two power take off assemblies. The first power take off assembly is a part of a continuous four wheel drive assembly 418 and the second power take off assembly is a part of a mechanical momentary four wheel drive assembly 420.

Referring also to FIGS. 9, 11, and 12B, the continuous four wheel drive assembly 418 can be used to have the rear ground engaging members 104 and front ground engaging members 104 be driven by the drive shaft 244. The continuous four wheel drive assembly 418 includes a drive shaft 430, bearings 432, spacer 431, seal cap 436, and an output coupler 434. The drive shaft 430 is mechanically coupled to the protrusion 426. For example, the end of the drive shaft 430 can include splines that mesh with splines inside of the protrusion 426. The drive shaft 430 rotates with the drive shaft 244. The drive shaft 430 extends along the rotation axis 246 to exit the electric transaxle housing 160 at the end plate 156. The drive shaft 430 extends through two bearings 432 housed within the end plate 156 and out through the end plate 156. The drive shaft 430 can pass through the seal cap 436 to seal the drive shaft 430 against the opening. The drive shaft 430 also passes through the end cap 438. The bearings 432 allow the drive shaft 430 to rotate relative to the end plate 156. There are spacers 431 positioned on the drive shaft 430 between the bearings 432. The end of the drive shaft 430 is coupled to the output coupler 434. The output coupler 434 can be coupled to the drive shaft 430 to another drive shaft to drive front ground engaging members 104. For example, the drive shaft 430 can drive the front ground engaging members 104 through a front differential assembly that functions similar to the differential assembly 224.

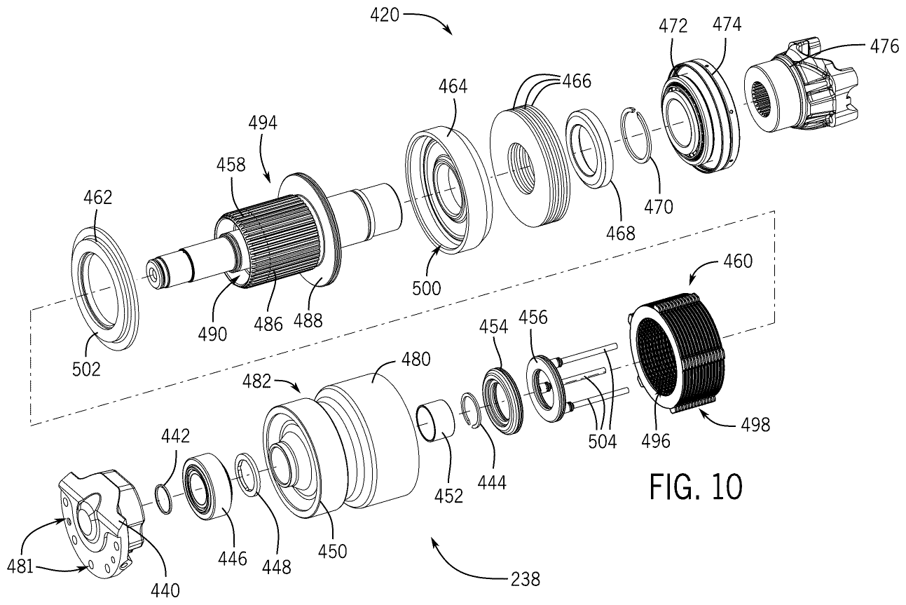

Referring also to FIGS. 10, 11, and 12B, the mechanical momentary four wheel drive assembly 420 can be used to have the rear ground engaging members 104 and front ground engaging members 104 be selectively driven by the drive shaft 244. For example, the rear ground engaging members 104 and front ground engaging members 104 are driven by the drive shaft 244 when the mechanical momentary four wheel drive assembly 420 is engaged, and only the rear ground engaging members 104 are driven by the drive shaft 244 when the mechanical momentary four wheel drive assembly 420 is disengaged. The mechanical momentary four wheel drive assembly 420 includes a mounting bracket 440, a ring 442, a snap ring 444, a bearing 446, a spacer 448, the third power shift clutch 238, a bushing 452, a drive shaft 458, a seal cap 474, a bearing 472, and an output coupler 476.

The mounting bracket 440 is attached to the electric transaxle housing 160. For example, the mounting bracket 440 can be bolted to the electric transaxle housing 160 through holes 481. The drive shaft 458 is inserted into the mounting bracket 440 through a bearing 446. The bearing 446 is positioned within the mounting bracket 440 and holds the bearing 446 in position. The bearing 446 allows the drive shaft 458 to rotate relative to the mounting bracket 440 and electric transaxle housing 160. The ring 442 is positioned in a channel defined by the drive shaft 458. The ring 442 extends larger than the diameter of the drive shaft to rest against an inner circumferential surface of the mounting bracket 440.

The drive shaft defines a rotation axis 478. The drive shaft 458 extends through the third power shift clutch 238. The third power shift clutch 238 includes a clutch gear 450, a thrust washer 454, a push member 456, a clutch pack 460, a thrust member 462, an actuation piston 464, an actuation spring 466, a spring stop 468, and a snap ring 470. The third power shift clutch 238 functions as a spring applied hydraulically released clutch. The drive shaft 458 extends through the clutch gear 450. The spacer 448 is positioned on the drive shaft 458 between the bearing 446 and the clutch gear 450. The bushing 452 is positioned between the clutch gear 450 and the drive shaft 458 such that the clutch gear 450 does not rest against the drive shaft 458. The clutch gear 450 includes gear teeth 482 that are meshed with gear teeth 484 of the third gear 422. Rotation of the drive shaft 244 and the third gear 422 cause the clutch gear 450 to rotate. The clutch gear 450 includes a protrusion 480 extending along the rotation axis 478 away from the mounting bracket 440. A clutch pack 460 is positioned within the protrusion 278. The clutch pack 460 couples the clutch gear 450 to the drive shaft 458. When the clutch pack 460 is engaged the clutch gear 450 and drive shaft 458 rotate together and when the clutch pack 460 is disengaged the clutch gear 450 and drive shaft 458 are no longer linked and rotate separately.

The drive shaft 458 includes a first protrusion 486 and a second protrusion 488. Both protrusions 486, 488 extend radially away from the rotation axis 478 with the second protrusion 488 extends farther than the first protrusion 486. An annular channel 490 is defined within the first protrusion 486 and one or more through holes 492 extend through the protrusions 486, 488 starting at the bottom of the annular channel 490. Splines 494 are positioned on the outer circumferential surface of the first protrusion 486.

The clutch pack 460 is positioned between the inner circumferential surface of the clutch gear 450 and the first protrusion 486 of the drive shaft 458. The clutch pack 460 includes alternately interleaved plates and friction discs that are alternately coupled to the clutch gear 450 and the drive shaft 458. For example, the clutch pack 460 includes clutch members that have inner teeth 496 that mesh to splines 494 of the drive shaft 458 and the other clutch members have protrusions 498 that mate with channels within the clutch gear 450. As such, when the clutch pack 460 is engaged, the clutch gear 450 and the drive shaft 458 rotate together.

The clutch pack 460 is engaged by the actuation piston 464 pressing a thrust member 462 against the clutch pack 460 to compress the clutch pack 460 against the clutch gear 450. The thrust member 462 is positioned on the drive shaft 458 between the clutch pack 460 and the second protrusion 488. The actuation piston 464 is positioned on the drive shaft 458 on the opposite side of the second protrusion 488 from the thrust member 462. The actuation piston 464 and the thrust member 462 both extend away from the rotation axis 478 farther than the second protrusion 488. The actuation piston 464 defines a cutout 500 that allows the actuation piston 464 to slide past the second protrusion 488. The actuation piston 464 rests against a radial outer end of the thrust member 462 and presses the thrust member 462 toward the clutch pack 460. The thrust member 462 includes a protrusion 502 that extends within the protrusion 480 to reach the clutch pack 460.

One or more actuation springs 466 are positioned on the drive shaft 458 between the actuation piston 464 and the spring stop 468. A snap ring 470 is positioned within an annular channel of the drive shaft 458. The snap ring 470 holds the spring stop 468 in position to not allow the spring stop 468 to slide past the snap ring 470. The actuation springs 466 press the spring stop 468 against the snap ring 470. As such the biasing force of the actuation springs 466 bias the actuation piston 464 toward the second protrusion 488 and clutch pack 460. In at least one aspect, the actuation springs 466 are compression springs. For example, the actuation springs 466 are one or more bevel springs. As such, the biasing force from the actuation springs 466 causes the actuation piston 464 and thrust member 462 to engage the clutch pack 460. Therefore, the clutch pack 460 is engaged by the actuation springs 466, which causes the clutch pack 460 to be spring applied. As such, in a passive state the clutch is engaged.

The push member 456 is positioned within the annular channel 490 with one or more protrusions 504 extending through one or more through holes 492 to rest against the annular piston 464. The thrust washer 454 is positioned within the annular channel 490 against the push member 456 on a side away from the protrusions 504. A snap ring 444 is positioned in an annular channel within the drive shaft 458. The snap ring 444 keeps the thrust washer 454 and push member 456 from sliding out of the annular channel 490. The user can disengaged the clutch pack 460 turning off four wheel drive through the operator interface 124. To disengaged the clutch pack 460 the control system 120 operates the valves 242 to direct hydraulic fluid through the hydraulic circuit toward the thrust washer 454. The pressure of the hydraulic fluid causes the thrust washer 454 to press against the push member 456 translating the thrust washer 454 and push member 456 toward the second protrusion 488. The translation of the push member 456 toward the second protrusion 488 causes the protrusions 504 to press the actuation piston 464 away from the clutch pack 460. With the thrust member 462 no longer being pressed against the clutch pack 460, the clutch pack 460 becomes disengaged similar to clutch pack 266, where there is slipping before becoming fully disengaged.

To move the actuation piston 464 away from the clutch pack 460, the hydraulic fluid pressure must move the push member 456 with a force great enough to overcome the biasing force from the actuation springs 466. As the actuation piston 464 moves away from the clutch pack 460 the actuation springs 466 become more compressed increasing the biasing force. The user can engaged the clutch pack 460 turning on four wheel drive through the operator interface 124. The control system 120 would control the valves 242 to decrease the hydraulic fluid flow through the hydraulic circuit toward the thrust washer 454. The hydraulic fluid pressure would decrease causing the biasing force from the actuation springs 466 to overcome the force against the thrust washer 454 by the hydraulic fluid. As such, the actuation piston 464 would translate toward the clutch pack 460 and cause the thrust member 462 to compress the clutch pack 460 and press the push member 456 and thrust washer 454 toward snap ring 444.

The drive shaft 458 extends through the electric transaxle housing 160 along the rotation axis 478 and out of the electric transaxle housing 160. The drive shaft 458 extends through a bearing 472 housed within the electric transaxle housing 160. The bearing 472 allows the drive shaft 458 to rotate relative to the electric transaxle housing 160. The drive shaft 458 also extends through the seal cap 474 to seal drive shaft 458 against the opening. The end of the drive shaft 458 is coupled to the output coupler 476. The output coupler 476 can couple the drive shaft 458 to another drive shaft to drive the front ground engaging members 104, when the four wheel drive is engaged. For example, when the four wheel drive is engaged, the drive shaft 458 can drive the front ground engaging members 104 through a front differential assembly that functions similar to the differential assembly 224. An operator can engaged the four wheel drive through the operator interface 124 and have the control system 120 control the valves 242 to cause the clutch pack 460 to be engaged. Similarly, the operator can disengaged the four wheel drive through the operator interface to have the work vehicle be rear wheel driven.

Additionally, work vehicle 100 can be only rear drive by not using the continuous four wheel drive assembly 418 nor the mechanical momentary four wheel drive assembly 420. As such, these assemblies 418, 420 could be not installed in the work vehicle 100 or the assemblies 418, 420 could be installed and the output couplers 434, 476 not used. As such, the work vehicle 100 can be only rear drive, selectively four wheel drive, or always four wheel drive through the use or not use of the assemblies 418, 420. The type of four wheel drive mode can be selected based on the type of work vehicle 100 or can be chosen upon manufacturing.

As used herein, “e.g.” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

While the above describes example embodiments of the present disclosure, these descriptions should not be viewed in a limiting sense. Rather, other variations and modifications may be made without departing from the scope and spirit of the present disclosure as defined in the appended claims.

Although the present disclosure has been described with reference to example implementations, workers skilled in the art will recognize that changes may be made in form and detail without departing from the spirit and scope of the claimed subject matter. For example, although different example implementations may have been described as including features providing one or more benefits, it is contemplated that the described features may be interchanged with one another or alternatively be combined with one another in the described example implementations or in other alternative implementations. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure. Although portions of the disclosure may use the phrase “at least one” or “one or more” of a particular component or element, unless otherwise specifically limited, the mere recitation of a single element or component does not preclude a plurality of such elements or components.

What is claimed is:

1. An electric transaxle for a work vehicle comprising:
a transaxle housing;
an electric machine mounted to or contained at least in part within the transaxle housing;
a multiple-speed power shift transmission driven by the electric machine and including a first gear set with a first power shift clutch to provide a first speed ratio and a second gear set with a second power shift clutch to provide a second speed ratio different than the first speed ratio;
a cooling system including a cooler cooling a cooling circuit mounted to or contained at least in part within the transaxle housing and configured to cool the electric machine; and
a hydraulic system including a hydraulic pump and a hydraulic circuit mounted to or contained at least in part within the transaxle housing to operate the first and second power shift clutches of the first and second gear sets, the hydraulic circuit being cooled by the cooler of the cooling system.

2. The electric transaxle of claim 1, wherein the first gear set is identical to the second gear set and the first and second gear sets are arranged in opposite axial orientations.

3. The electric transaxle of claim 2, wherein the first gear set includes a first shaft extending along a first rotation axis and carrying a first large gear spaced along the first rotation axis from a first small gear;
wherein the second gear set includes a second shaft extending along a second rotation axis, parallel to the first rotation axis, and carrying a second large gear, identical to the first large gear, spaced along the second rotation axis from a second small gear, identical to the first small gear; and
wherein the first small gear meshes with the second large gear to provide the first speed ratio and wherein the first large gear meshes with the second small gear to provide the second speed ratio.

4. The electric transaxle of claim 3, wherein the multiple-speed power shift transmission provides power at the first speed ratio when the first power shift clutch is engaged and the second power shift clutch is disengaged; and
wherein the multiple-speed power shift transmission provides power at the second speed ratio when the second power shift clutch is engaged and the first power shift clutch is engaged.

5. The electric transaxle of claim 4, further including an output gear coupled to or part of the second shaft of the second gear set and outputting power at the first speed ratio when the first power shift clutch is engaged and the second power shift clutch is disengaged and at the second speed ratio when the second power shift clutch is engaged and the first power shift clutch is disengaged.

6. The electric transaxle of claim 5, wherein the output gear is a spiral bevel gear meshing with a face of drive ring gear of the transaxle.

7. The electric transaxle of claim 6, further including a differential mounted to or contained at least in part within the transaxle housing and receiving power from the drive ring gear.

8. The electric transaxle of claim 7, further including a first final drive mounted to or contained at least in part within the transaxle housing at a first side of the differential and providing a final gear ratio to a first hub configured to mount a first ground-engaging wheel or track; and
a second final drive mounted to or contained at least in part within the transaxle housing at a second side of the differential and providing the final gear ratio to a second hub configured to mount a second ground-engaging wheel or track.

9. The electric transaxle of claim 3, further including one or more of:
a first power take off assembly mounted to or contained at least in part within the transaxle housing and configured to receive power from or transmit power to the multiple-speed power shift transmission at the first speed ratio or the second speed ratio; or
a second power take off assembly mounted to or contained at least in part within the transaxle housing and configured to receive power from or transmit power to the multiple-speed power shift transmission at the first speed ratio or the second speed ratio.

10. The electric transaxle of claim 9, wherein the first power take off assembly is a part of a continuous four wheel drive assembly and wherein the second power take off assembly is a part of a mechanical momentary four wheel drive assembly.

11. A work vehicle comprising:
a chassis supported off the ground by ground-engaging wheels or tracks; and
an electric transaxle carried by the chassis and driving the ground-engaging wheels or tracks, the electric transaxle including:
a transaxle housing;
an electric machine mounted to or contained at least in part within the transaxle housing;
a multiple-speed power shift transmission driven by the electric machine and including a first gear set with a first power shift clutch and providing a first speed ratio and a second gear set with a second power shift clutch and providing a second speed ratio different than the first speed ratio;
a cooling system including a cooler cooling a cooling circuit mounted to or contained at least in part within the transaxle housing and configured to cool the electric machine; and
a hydraulic system including a hydraulic pump and a hydraulic circuit mounted to or contained at least in part within the transaxle housing to operate the first and second power shift clutches of the first and second gear sets, the hydraulic circuit being cooled by the cooler of the cooling system.

12. The work vehicle of claim 11, wherein the first gear set is identical to the second gear set and the first and second gear sets are arranged in opposite axial orientations.

13. The work vehicle of claim 12, wherein the first gear set includes a first shaft extending along a first rotation axis and carrying a first large gear spaced along the first rotation axis from a first small gear;
wherein the second gear set includes a second shaft extending along a second rotation axis, parallel to the first rotation axis, and carrying a second large gear, identical to the first large gear, spaced along the second rotation axis from a second small gear, identical to the first small gear; and
wherein the first small gear meshes with the second large gear to provide the first speed ratio and wherein the first large gear meshes with the second small gear to provide the second speed ratio.

14. The work vehicle of claim 13, wherein the multiple-speed power shift transmission provides power at the first speed ratio when the first power shift clutch is engaged and the second power shift clutch is disengaged; and
wherein the multiple-speed power shift transmission provides power at the second speed ratio when the second power shift clutch is engaged and the first power shift clutch is engaged.

15. The work vehicle of claim 14, wherein the electric transaxle further includes an output gear coupled to or part of the second shaft of the second gear set and outputting power at the first speed ratio when the first power shift clutch is engaged and the second power shift clutch is disengaged and at the second speed ratio when the second power shift clutch is engaged and the first power shift clutch is engaged.

16. The work vehicle of claim 15, wherein the output gear is a spiral bevel gear meshing with a face of drive ring gear of the transaxle.

17. The work vehicle of claim 16, further including a differential mounted to or contained at least in part within the transaxle housing and receiving power from the drive ring gear.

18. The work vehicle of claim 17, further including a first final drive mounted to or contained at least in part within the transaxle housing at a first side of the differential and providing a final gear ratio to a first hub configured to mount a first of the ground-engaging wheels or tracks; and
a second final drive mounted to or contained at least in part within the transaxle housing at a second side of the differential and providing the final gear ratio to a second hub configured to mount a second of the ground-engaging wheels or tracks.

19. The work vehicle of claim 13, further including one or more of:
a first power take off assembly mounted to or contained at least in part within the transaxle housing and configured to receive power from or transmit power to the multiple-speed power shift transmission at the first speed ratio or the second speed ratio; or
a second power take off assembly mounted to or contained at least in part within the transaxle housing and configured to receive power from or transmit power to the multiple-speed power shift transmission at the first speed ratio or the second speed ratio.

20. The work vehicle of claim 19, wherein the first power take off assembly is a part of a continuous four wheel drive assembly and wherein the second power take off assembly is a part of a mechanical momentary four wheel drive assembly.
